(19) United States
(12) Patent Application Publication
(10) Pub. No.: US 2026/0080633 A1
(43) Pub. Date: Mar. 19, 2026

(54) DEPTH ESTIMATION USING ODOMETRY AND HAND TRACKING

(71) Applicant: Snap Inc., Santa Monica, CA (US)

(72) Inventors: Georgios Evangelidis, Vienna (AT); Vesvolod Konjahhin, Vienna (AT); Jakob Zillner, Absdorf (AT); Tobias Maier, Vienna (AT); Dario Fontanel, Vienna (AT); Feliks Hibraj, Vienna (AT); Jeremias Beyene Yehdegho, Vienna (AT); Dmytro Siryk, Vienna (AT); Ihor Tymchyshyn, Kyiv (UA)

(21) Appl. No.: 18/931,491

(22) Filed: Oct. 30, 2024

(30) Foreign Application Priority Data
Sep. 16, 2024 (GR) 20240100633

(51) Int. Cl. G06T 19/00; G02B 27/01; G06F 3/01; G06T 7/246; G06T 7/55; G06V 10/70; G06V 10/80; G06V 20/20; G06V 40/10

(52) U.S. Cl. CPC G06T 19/006; G02B 27/0172; G06F 3/011; G06T 7/246; G06T 7/55; G06V 10/80; G06V 10/87; G06V 20/20; G06V 40/107; G06V 2201/07

(57) ABSTRACT

A head-worn augmented reality (AR) device system includes cameras, display devices, and processors, along with a memory that stores specific instructions. When these instructions are executed by the processors, they enable the device to perform several operations. First, the device accesses a two-dimensional (2D) camera image taken by its camera. The device then generates a first set of three-dimensional (3D) tracked points using the device's odometry system applied to this 2D image. Optionally, a second set of tracked 3D points is created based on one or more images captured by the camera. These 3D points are projected onto the 2D camera image to create a sparse depth image. Finally, this 2D camera image, along with the newly formed depth image, is fed into a first machine learning model to generate a metric depth estimation.

### PRIORITY

This patent application claims the benefit of priority to Greece application No. 20240100633, filed Sep. 16, 2024, which is incorporated by reference herein in its entirety.

### TECHNICAL FIELD

The present disclosure relates generally to display devices and more particularly to display devices used for augmented and virtual reality.

### BACKGROUND

A head-worn device may be implemented with a transparent or semi-transparent display through which a user of the head-worn device can view the surrounding environment. Such devices enable a user to see through the transparent or semi-transparent display to view the surrounding environment, and to also see objects (e.g., virtual objects such as 3D renderings, images, video, text, and so forth) that are generated for display to appear as a part of, and/or overlaid upon, the surrounding environment. This is typically referred to as “augmented reality” or “AR.” A head-worn device may additionally completely occlude a user's visual field and display a virtual environment through which a user may move or be moved. This is typically referred to as “virtual reality” or “VR.” Collectively, AR and VR as known as “XR” where “X” is understood to stand for either “augmented” or “virtual.” As used herein, the term XR refers to either or both augmented reality and virtual reality as traditionally understood, unless the context indicates otherwise.

A user of the head-worn device may access and use a computer software application to perform various tasks or engage in an entertaining activity. To use the computer software application, the user interacts with a 3D user interface provided by the head-worn device.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a perspective view of a head-worn device, in accordance with some examples.

FIG. 2 illustrates a further view of the head-worn device of FIG. 1, in accordance with some examples.

FIG. 3 is a block diagram illustrating a networked system 300 including details of the head-worn device of FIG. 1, in accordance with some examples.

FIG. 4 is a diagrammatic representation of a networked environment in which the present disclosure may be deployed, according to some examples.

FIG. 5 is a diagrammatic representation of an interaction system that has both client-side and server-side functionality, according to some examples.

FIG. 6 is a diagrammatic representation of a data structure as maintained in a database, according to some examples.

FIG. 7 illustrates an example method 700 for generating metric depth estimation, according to some examples.

FIG. 8 illustrates an example of generating three dimensional points that are tracked by one or more algorithms, according to some examples.

FIG. 9 illustrates the generation of metric depth according to some examples.

FIG. 10 illustrates the improvement of the interaction system using 3D point removal and replacement, according to some examples.

FIG. 11 is a diagrammatic representation of a message, according to some examples.

FIG. 12 illustrates a system including a head-wearable apparatus with a selector input device, according to some examples.

FIG. 13 is a diagrammatic representation of a machine in the form of a computer system within which a set of instructions may be executed to cause the machine to perform any one or more of the methodologies discussed herein, according to some examples.

FIG. 14 is a block diagram showing a software architecture within which examples may be implemented.

FIG. 15 illustrates a machine-learning pipeline, according to some examples.

FIG. 16 illustrates training and use of a machine-learning program, according to some examples.

### DETAILED DESCRIPTION

Some head-worn XR devices, such as AR glasses, include a transparent or semi-transparent display that enables a user to see through the transparent or semi-transparent display to view the surrounding environment. Additional information or objects (e.g., virtual objects such as 3D renderings, images, video, text, and so forth) are shown on the display and appear as a part of, and/or overlaid upon, the surrounding environment to provide an augmented reality (AR) experience for the user. The display may for example include a waveguide that receives a light beam from a projector but any appropriate display for presenting augmented or virtual content to the wearer may be used.

As referred to herein, the phrase “augmented reality experience,” includes or refers to various image processing operations corresponding to an image modification, filter, media overlay, transformation, and the like, as described further herein. In some examples, these image processing operations provide an interactive experience of a real-world environment, where objects, surfaces, backgrounds, lighting and so forth in the real world are enhanced by computer-generated perceptual information. In this context an “augmented reality effect” comprises the collection of data, parameters, and other assets used to apply a selected augmented reality experience to an image or a video feed. In some examples, augmented reality effects are provided by Snap, Inc. under the registered trademark LENSES.

In some examples, a user's interaction with software applications executing on an XR device is achieved using a 3D User Interface. The 3D user interface includes virtual objects displayed to a user by the XR device in a 3D render displayed to the user. In the case of AR, the user perceives the virtual objects as objects within the real world as viewed by the user while wearing the XR device. In the case of VR, the user perceives the virtual objects as objects within the virtual world as viewed by the user while wearing the XR device To allow the user to interact with the virtual objects, the XR device detects the user's hand positions and movements and uses those hand positions and movements to determine the user's intentions in manipulating the virtual objects.

Generation of the 3D user interface and detection of the user's interactions with the virtual objects may also include detection of real world objects (e.g., faces, hands, bodies, cats, dogs, surfaces, objects), tracking of such real world objects as they leave, enter, and move around the field of view in video frames, and the modification or transformation of such real world objects as they are tracked. In various examples, different methods for detecting the real world objects and achieving such transformations may be used. For example, some examples may involve generating a 3D mesh model of a real world object or real world objects, and using transformations and animated textures of the model within the video frames to achieve the transformation. In other examples, tracking of points on a real world object may be used to place an image or texture, which may be two dimensional or three dimensional, at the tracked position. In still further examples, neural network analysis of video frames may be used to place images, models, or textures in content (e.g., images or frames of video). XR effect data thus may include both the images, models, and textures used to create transformations in content, as well as additional modeling and analysis information used to achieve such transformations with real world object detection, tracking, and placement.

Other technical features may be readily apparent to one skilled in the art from the following figures, descriptions, and claims.

Traditional systems for depth estimation and object tracking, especially in augmented reality (AR) environments, face a range of challenges and limitations that can impact their accuracy, efficiency, and overall effectiveness.

Traditional depth estimation techniques often struggle with scale accuracy. Such systems may correctly identify the shape and relative position of objects but fail to provide true-to-scale distances. This is particularly problematic in applications requiring precise spatial interactions.

Errors in depth measurement can propagate through the system, leading to inaccuracies in object placement and interaction within AR environments. Small initial errors can become significant in complex or dynamic scenes.

Traditional systems can have difficulty accurately tracking objects that become occluded. For instance, if an object or a part of the body (like a hand) is temporarily hidden from view, the system may lose track of it or fail to accurately reacquire it once it reappears.

Many systems rely heavily on the texture of objects to estimate depth, which can lead to poor performance in environments with textureless surfaces or repetitive patterns that confuse the tracking algorithms.

Depth estimation and real-time tracking often require substantial computational resources, which can be taxing on the hardware of portable devices such as smartphones or AR headsets. This can lead to slower response times and reduced battery life.

Implementing robust depth sensing and object tracking technologies often involves complex software and hardware integration, which can be challenging to optimize and maintain across different device types and operating platforms.

Traditional systems may not adapt well to rapidly changing environmental conditions, such as varying lighting or sudden movements within the scene. This can reduce the reliability of depth estimations and object interactions.

Accurate depth sensing is often compromised by poor lighting conditions. For example, too much brightness can cause glare in camera sensors, while too little light can reduce the contrast needed to detect and track objects effectively.

Traditional depth estimation systems may struggle to generalize to new or unstructured settings due to overfitting during the training phase. Systems can be sensitive to noise and interference, such as reflective surfaces or objects that disrupt sensor readings, leading to inconsistent or erroneous depth data.

These issues underline some of the fundamental challenges that traditional depth estimation and tracking systems face in providing accurate, efficient, and user-friendly AR experiences.

Example embodiments of the interaction system described herein mitigate or eliminate the deficiencies of such traditional systems. The interaction system utilizes advanced neural networks to generate metric depth estimations that are scaled to real-world dimensions. This approach corrects the common issue of scale mismatch found in traditional systems.

By applying a global scale correction based on differences between estimated and actual depth points, the system ensures that the depth data is not only accurate relative to the scene but also true to absolute measurements. This is helpful for applications where precise physical interaction with virtual objects is required.

The interaction system is designed to intelligently handle occlusions, especially dynamic ones such as moving hands or objects that temporarily block other elements. The interaction system uses advanced tracking algorithms that can predict and infer the position of occluded or occluding objects based on previous and surrounding data points.

By leveraging depth data directly and using sophisticated image processing techniques, the interaction system reduces reliance on surface textures, which helps in environments with poor or repetitive textures.

The interaction system employs optimized algorithms that are tailored to run efficiently on AR hardware. This reduces the computational load, allowing the system to operate smoothly even on less powerful devices.

By integrating depth estimation directly with object tracking within the same neural network framework, the interaction system streamlines data processing, reducing the latency and resource consumption typically associated with separate processing paths.

The interaction system is designed to adapt dynamically to changing environmental conditions. The interaction system utilizes real-time feedback to adjust its depth sensing and tracking parameters, ensuring consistent performance under various lighting conditions and movements.

The interaction system employs imaging technologies and calibration techniques to mitigate issues caused by variable lighting, such as glare or shadows, ensuring reliable depth estimation regardless of lighting conditions.

The neural networks used by the interaction system are trained on diverse datasets that include a wide range of environments and scenarios, enhancing the system's ability to generalize across different settings.

By providing accurate and real-time depth tracking, the interaction system allows for more natural and intuitive interactions with virtual objects. Users can manipulate virtual elements in ways that feel consistent with their interactions with the real world.

By addressing these specific deficiencies of traditional systems, the interaction system significantly enhances the utility and applicability of AR technologies, making them more effective for a range of applications from entertainment and gaming to professional and educational tools. This comprehensive approach ensures a more immersive, reliable, and enjoyable user experience.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in the depth map estimation process. Computing resources used by one or more machines, databases, or networks may thus be more efficiently utilized or even reduced.

### Headworn XR Device

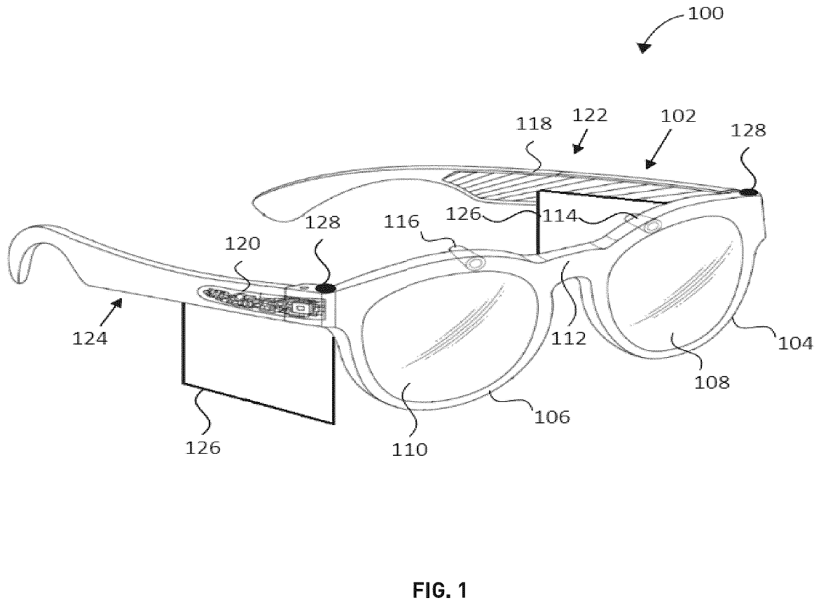

FIG. 1 is perspective view of a head-worn XR device (e.g., glasses 100), in accordance with some examples. The glasses 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the glasses 100.

The frame 102 additionally includes a left arm or temple piece and a right arm or temple piece 124. In some examples the frame 102 can be formed from a single piece of material so as to have a unitary or integral construction.

The glasses 100 can include a computing device, such as a computer 120, which can be of any suitable type so as to be carried by the frame 102 and, in one or more examples, of a suitable size and shape, so as to be partially disposed in one of the temple piece 122 or the temple piece 124. The computer 120 can include one or more processors with memory, wireless communication circuitry, and a power source. As discussed below, the computer 120 comprises low-power circuitry, high-speed circuitry, and a display processor. Various other examples may include these elements in different configurations or integrated together in different ways. Additional details of aspects of computer 120 may be implemented as illustrated by the data processor 302 discussed below.

The computer 120 additionally includes a battery 118 or other suitable portable power supply. In some examples, the battery 118 is disposed in left temple piece and is electrically coupled to the computer 120 disposed in the right temple piece 124. The glasses 100 can include a connector or port (not shown) suitable for charging the battery 118, a wireless receiver, transmitter or transceiver (not shown), or a combination of such devices.

The glasses 100 include a first or left camera 114 and a second or right camera 116. Although two cameras are depicted, other examples contemplate the use of a single or additional (i.e., more than two) cameras. In one or more examples, the glasses 100 include any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide video frame data for use by the glasses 100 to extract 3D information from a real world scene.

The glasses 100 may also include a touchpad 126 mounted to or integrated with one or both of the left temple piece and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input may be provided by one or more buttons 128, which in the illustrated examples are provided on the outer upper edges of the left optical element holder 104 and right optical element holder 106. The one or more touchpads 126 and buttons 128 provide a means whereby the glasses 100 can receive input from a user of the glasses 100.

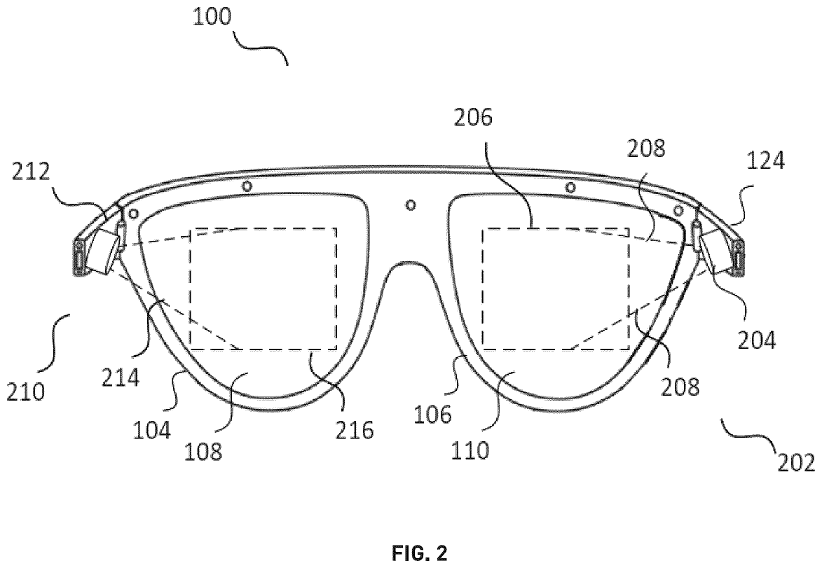

FIG. 2 illustrates the glasses 100 from the perspective of a user. For clarity, a number of the elements shown in FIG. 1 have been omitted. As described in FIG. 1, the glasses 100 shown in FIG. 2 include left optical element 108 and right optical element 110 secured within the left optical element holder 104 and the right optical element holder 106 respectively.

The glasses 100 include forward optical assembly 202 comprising a right projector 204 and a right near eye display 206, and a forward optical assembly 210 including a left projector 212 and a left near eye display 216.

In some examples, the near eye displays are waveguides. The waveguides include reflective or diffractive structures (e.g., gratings and/or optical elements such as mirrors, lenses, or prisms). Light 208 emitted by the projector 204 encounters the diffractive structures of the waveguide of the near eye display 206, which directs the light towards the right eye of a user to provide an image on or in the right optical element 110 that overlays the view of the real world seen by the user. Similarly, light 214 emitted by the projector 212 encounters the diffractive structures of the waveguide of the near eye display 216, which directs the light towards the left eye of a user to provide an image on or in the left optical element 108 that overlays the view of the real world seen by the user. The combination of a GPU, the forward optical assembly 202, the left optical element 108, and the right optical element 110 provide an optical engine of the glasses 100. The glasses 100 use the optical engine to generate an overlay of the real world view of the user including display of a 3D user interface to the user of the glasses 100.

It will be appreciated however that other display technologies or configurations may be utilized within an optical engine to display an image to a user in the user's field of view. For example, instead of a projector 204 and a waveguide, an LCD, LED or other display panel or surface may be provided.

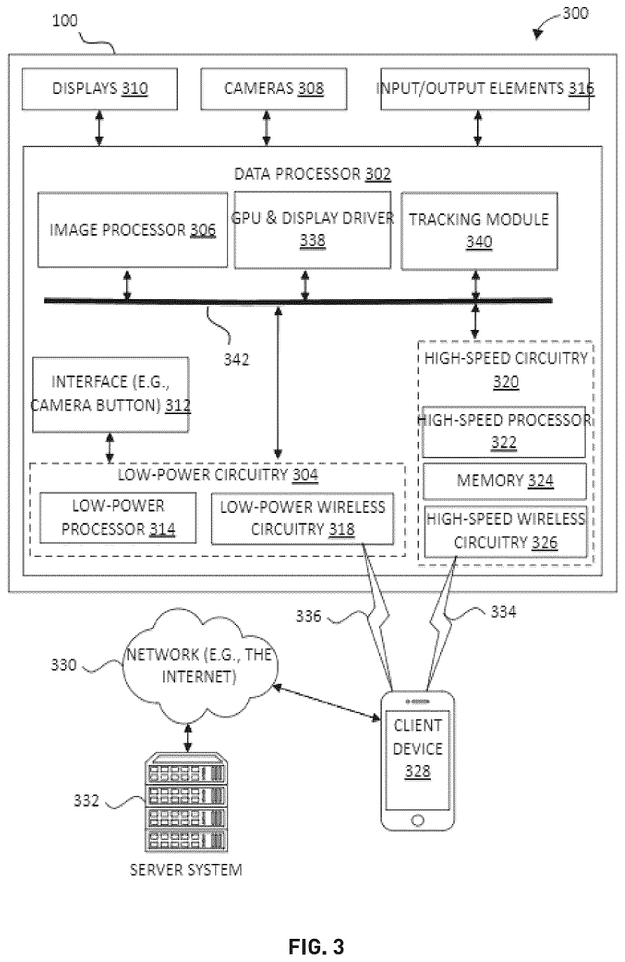

In use, a user of the glasses 100 will be presented with information, content and various 3D user interfaces on the near eye displays. As described in more detail herein, the user can then interact with the glasses 100 using a touchpad 126 and/or the buttons 128, voice inputs or touch inputs on an associated device (e.g. client device 328 illustrated in FIG. 3), and/or hand movements, locations, and positions detected by the glasses 100.

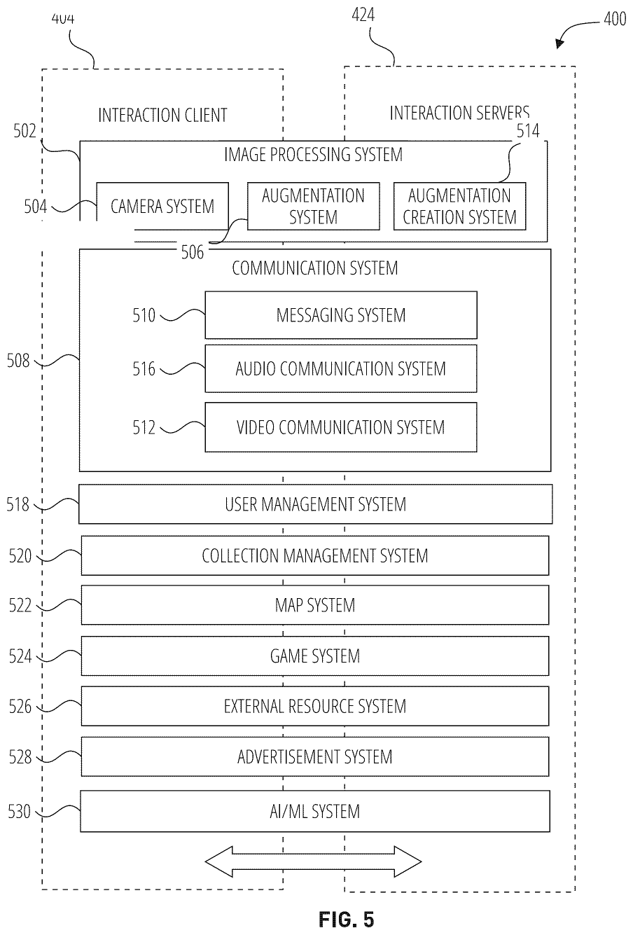

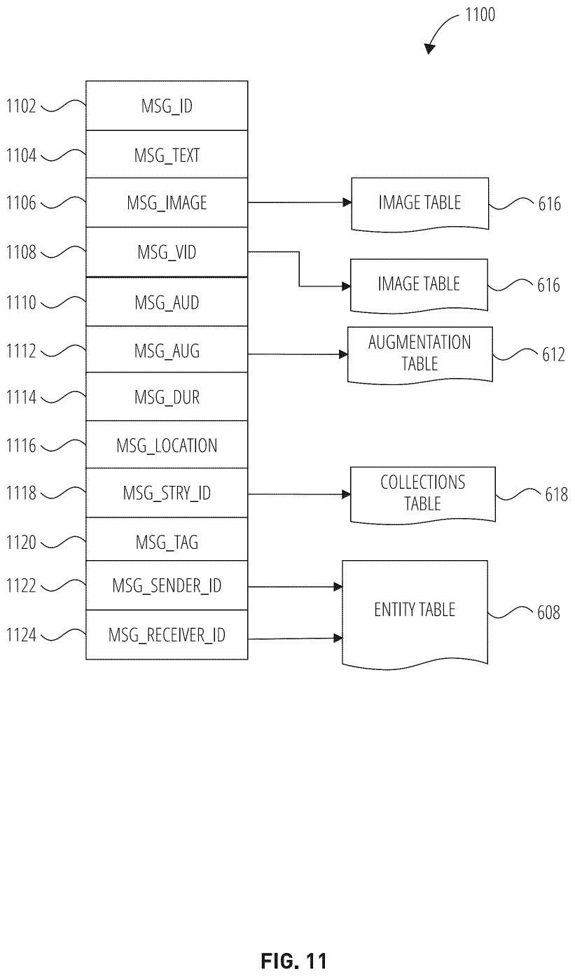

FIG. 3 is a block diagram illustrating a networked system 300 including details of the glasses 100, in accordance with some examples. The networked system 300 includes the glasses 100, a client device 328, and a server system 332. The client device 328 may be a smartphone, tablet, phablet, laptop computer, access point, or any other such device capable of connecting with the glasses 100 using a low-power wireless connection 336 and/or a high-speed wireless connection 334. The client device 328 is connected to the server system 332 via the network 330. The network 330 may include any combination of wired and wireless connections. The server system 332 may be one or more computing devices as part of a service or network computing system. The client device 328 and any elements of the server system 332 and network 330 may be implemented using details of the software architecture or the machine described in FIG. 5 and FIG. 11 respectively.

The glasses 100 include a data processor 302, displays 310, one or more cameras 308, and additional input/output elements 316. The input/output elements 316 may include microphones, audio speakers, biometric sensors, additional sensors, or additional display elements integrated with the data processor 302. Examples of the input/output elements 316 are discussed further with respect to FIG. 5 and FIG. 11. For example, the input/output elements 316 may include any of I/O components 1106 including user output components 1324, motion components 1330, and so forth. Examples of the displays 310 are discussed in FIG. 2. In the particular examples described herein, the displays 310 include a display for the user's left and right eyes.

The data processor 302 includes an image processor 306 (e.g., a video processor), a GPU & display driver 338, a tracking module 340, an interface 312, low-power circuitry 304, and high-speed circuitry 320. The components of the data processor 302 are interconnected by a bus 342.

The interface 312 refers to any source of a user command that is provided to the data processor 302. In one or more examples, the interface 312 is a physical button that, when depressed, sends a user input signal from the interface 312 to a low-power processor 314. A depression of such button followed by an immediate release may be processed by the low-power processor 314 as a request to capture a single image, or vice versa. A depression of such a button for a first period of time may be processed by the low-power processor 314 as a request to capture video data while the button is depressed, and to cease video capture when the button is released, with the video captured while the button was depressed stored as a single video file. Alternatively, depression of a button for an extended period of time may capture a still image. In some examples, the interface 312 may be any mechanical switch or physical interface capable of accepting user inputs associated with a request for data from the cameras 308. In other examples, the interface 312 may have a software component, or may be associated with a command received wirelessly from another source, such as from the client device 328.

The image processor 306 includes circuitry to receive signals from the cameras 308 and process those signals from the cameras 308 into a format suitable for storage in the memory 324 or for transmission to the client device 328. In one or more examples, the image processor 306 (e.g., video processor) comprises a microprocessor integrated circuit (IC) customized for processing sensor data from the cameras 308, along with volatile memory used by the microprocessor in operation.

The low-power circuitry 304 includes the low-power processor 314 and the low-power wireless circuitry 318. These elements of the low-power circuitry 304 may be implemented as separate elements or may be implemented on a single IC as part of a system on a single chip. The low-power processor 314 includes logic for managing the other elements of the glasses 100. As described above, for example, the low-power processor 314 may accept user input signals from the interface 312. The low-power processor 314 may also be configured to receive input signals or instruction communications from the client device 328 via the low-power wireless connection 336. The low-power wireless circuitry 318 includes circuit elements for implementing a low-power wireless communication system. Bluetooth™ Smart, also known as Bluetooth™ low energy, is one standard implementation of a low power wireless communication system that may be used to implement the low-power wireless circuitry 318. In other examples, other low power communication systems may be used.

The high-speed circuitry 320 includes a high-speed processor 322, a memory 324, and a high-speed wireless circuitry 326. The high-speed processor 322 may be any processor capable of managing high-speed communications and operation of any general computing system used for the data processor 302. The high-speed processor 322 includes processing resources used for managing high-speed data transfers on the high-speed wireless connection 334 using the high-speed wireless circuitry 326. In some examples, the high-speed processor 322 executes an operating system such as a LINUX operating system or other such operating system. In addition to any other responsibilities, the high-speed processor 322 executing a software architecture for the data processor 302 is used to manage data transfers with the high-speed wireless circuitry 326. In some examples, the high-speed wireless circuitry 326 is configured to implement Institute of Electrical and Electronic Engineers (IEEE) 1102.11 communication standards, also referred to herein as Wi-Fi. In other examples, other high-speed communications standards may be implemented by the high-speed wireless circuitry 326.

The memory 324 includes any storage device capable of storing camera data generated by the cameras 308 and the image processor 306. While the memory 324 is shown as integrated with the high-speed circuitry 320, in other examples, the memory 324 may be an independent standalone element of the data processor 302. In some such examples, electrical routing lines may provide a connection through a chip that includes the high-speed processor 322 from image processor 306 or the low-power processor 314 to the memory 324. In other examples, the high-speed processor 322 may manage addressing of the memory 324 such that the low-power processor 314 will boot the high-speed processor 322 any time that a read or write operation involving the memory 324 is desired.

The tracking module 340 estimates a pose of the glasses 100. For example, the tracking module 340 uses image data and corresponding inertial data from the cameras 308 and the position components, as well as GPS data, to track a location and determine a pose of the glasses 100 relative to a frame of reference (e.g., real-world environment). The tracking module 340 continually gathers and uses updated sensor data describing movements of the glasses 100 to determine updated three-dimensional poses of the glasses 100 that indicate changes in the relative position and orientation relative to physical objects in the real-world environment. The tracking module 340 permits visual placement of virtual objects relative to physical objects by the glasses 100 within the field of view of the user via the displays 310.

The GPU & display driver 338 may use the pose of the glasses 100 to generate frames of virtual content or other content to be presented on the displays 310 when the glasses 100 are functioning in a traditional augmented reality mode. In this mode, the GPU & display driver 338 generates updated frames of virtual content based on updated three-dimensional poses of the glasses 100, which reflect changes in the position and orientation of the user in relation to physical objects in the user's real-world environment.

One or more functions or operations described herein may also be performed in an Application resident on the glasses 100 or on the client device 328, or on a remote server. For example, one or more functions or operations described herein may be performed by one of the applications such as messaging application.

### Networked Computing Environment

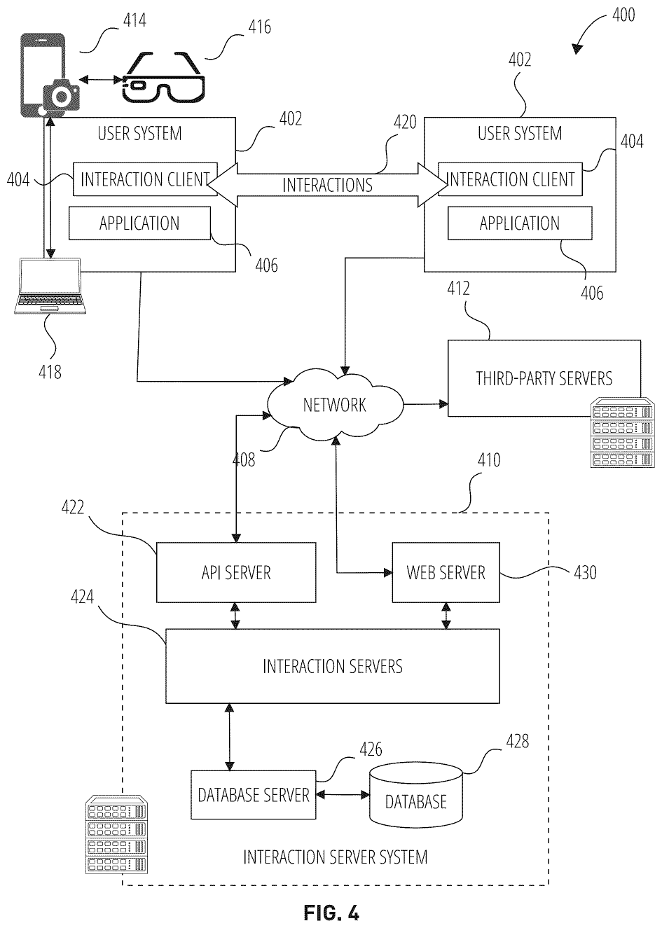

FIG. 4 is a block diagram showing an example interaction system 400 for facilitating interactions (e.g., exchanging text messages, conducting text audio and video calls, or playing games) over a network. The interaction system 400 includes multiple user systems 402, each of which hosts multiple applications, including an interaction client 404 and other applications 406. Each interaction client 404 is communicatively coupled, via one or more communication networks including a network 408 (e.g., the Internet), to other instances of the interaction client 404 (e.g., hosted on respective other user systems), an interaction server system 410 and third-party servers 412). An interaction client 404 can also communicate with locally hosted applications 406 using Applications Programming Interfaces (APIs).

Each user system 402 may include multiple user devices, such as a mobile device 414, head-wearable apparatus 416, and a computer client device 418 that are communicatively connected to exchange data and messages.

An interaction client 404 interacts with other interaction clients 404 and with the interaction server system 410 via the network 408. The data exchanged between the interaction clients 404 (e.g., interactions 420) and between the interaction clients 404 and the other interaction server system 410 includes functions (e.g., commands to invoke functions) and payload data (e.g., text, audio, video, or other multimedia data).

The interaction server system 410 provides server-side functionality via the network 408 to the interaction clients 404. While certain functions of the interaction system 400 are described herein as being performed by either an interaction client 404 or by the interaction server system 410, the location of certain functionality either within the interaction client 404 or the interaction server system 410 may be a design choice. For example, it may be technically preferable to initially deploy particular technology and functionality within the interaction server system 410 but to later migrate this technology and functionality to the interaction client 404 where a user system 402 has sufficient processing capacity.

The interaction server system 410 supports various services and operations that are provided to the interaction clients 404. Such operations include transmitting data to, receiving data from, and processing data generated by the interaction clients 404. This data may include message content, client device information, geolocation information, media augmentation and overlays, message content persistence conditions, entity relationship information, and live event information. Data exchanges within the interaction system 400 are invoked and controlled through functions available via user interfaces (UIs) of the interaction clients 404.

Turning now specifically to the interaction server system 410, an API server 422 is coupled to and provides programmatic interfaces to interaction servers 424, making the functions of the interaction servers 424 accessible to interaction clients 404, other applications 406 and third-party server 412. The interaction servers 424 are communicatively coupled to a database server 426, facilitating access to a database 428 that stores data associated with interactions processed by the interaction servers 424. Similarly, a web server 430 is coupled to the interaction servers 424 and provides web-based interfaces to the interaction servers 424. To this end, the web server 430 processes incoming network requests over the Hypertext Transfer Protocol (HTTP) and several other related protocols.

The API server 422 receives and transmits interaction data (e.g., commands and message payloads) between the interaction servers 424 and the user systems 402 (and, for example, interaction clients 404 and other application 406) and the third-party server 412. Specifically, the API server 422 provides a set of interfaces (e.g., routines and protocols) that can be called or queried by the interaction client 404 and other applications 406 to invoke functionality of the interaction servers 424. The API server 422 exposes various functions supported by the interaction servers 424, including account registration; login functionality; the sending of interaction data, via the interaction servers 424, from a particular interaction client 404 to another interaction client 404; the communication of media files (e.g., images or video) from an interaction client 404 to the interaction servers 424; the settings of a collection of media data (e.g., a story); the retrieval of a list of friends of a user of a user system 402; the retrieval of messages and content; the addition and deletion of entities (e.g., friends) to an entity relationship graph (e.g., the entity graph 610); the location of friends within an entity relationship graph; and opening an application event (e.g., relating to the interaction client 404).

The interaction servers 424 hosts multiple systems and subsystems, described below with reference to FIG. 5.

### Linked Applications

Returning to the interaction client 404, features and functions of an external resource (e.g., a linked application 406 or applet) are made available to a user via an interface of the interaction client 404. In this context, “external” refers to the fact that the application 406 or applet is external to the interaction client 404. The external resource is often provided by a third party but may also be provided by the creator or provider of the interaction client 404. The interaction client 404 receives a user selection of an option to launch or access features of such an external resource. The external resource may be the application 406 installed on the user system 402 (e.g., a “native app”), or a small-scale version of the application (e.g., an “applet”) that is hosted on the user system 402 or remote of the user system 402 (e.g., on third-party servers 412). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 404. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 404 determines whether the selected external resource is a web-based external resource or a locally installed application 406. In some cases, applications 406 that are locally installed on the user system 402 can be launched independently of and separately from the interaction client 404, such as by selecting an icon corresponding to the application 406 on a home screen of the user system 402. Small-scale versions of such applications can be launched or accessed via the interaction client 404 and, in some examples, no or limited portions of the small-scale application can be accessed outside of the interaction client 404. The small-scale application can be launched by the interaction client 404 receiving, from third-party servers 412 for example, a markup-language document associated with the small-scale application and processing such a document.

In response to determining that the external resource is a locally installed application 406, the interaction client 404 instructs the user system 402 to launch the external resource by executing locally stored code corresponding to the external resource. In response to determining that the external resource is a web-based resource, the interaction client 404 communicates with the third-party servers 412 (for example) to obtain a markup-language document corresponding to the selected external resource. The interaction client 404 then processes the obtained markup-language document to present the web-based external resource within a user interface of the interaction client 404.

The interaction client 404 can notify a user of the user system 402, or other users related to such a user (e.g., “friends”), of activity taking place in one or more external resources. For example, the interaction client 404 can provide participants in a conversation (e.g., a chat session) in the interaction client 404 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 404, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 404. The external resource can selectively include different media items in the responses, based on a current context of the external resource.

The interaction client 404 can present a list of the available external resources (e.g., applications 406 or applets) to a user to launch or access a given external resource. This list can be presented in a context-sensitive menu. For example, the icons representing different applications 406 (or applets) can vary based on how the menu is launched by the user (e.g., from a conversation interface or from a non-conversation interface).

### System Architecture

FIG. 5 is a block diagram illustrating further details regarding the interaction system 400, according to some examples. Specifically, the interaction system 400 is shown to comprise the interaction client 404 and the interaction servers 424. The interaction system 400 embodies multiple subsystems, which are supported on the client-side by the interaction client 404 and on the server-side by the interaction servers 424. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 400.
Data storage: A microservice subsystem may be responsible for its own data storage, which may be in the form of a database, cache, or other storage mechanism (e.g., using the database server 426 and database 428). This enables a microservice subsystem to operate independently of other microservices of the interaction system 400.
Service discovery: Microservice subsystems may find and communicate with other microservice subsystems of the interaction system 400. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 400 may employ a monolithic architecture, a service-oriented architecture (SOA), a function-as-a-service (FaaS) architecture, or a modular architecture:

Example subsystems are discussed below.

An image processing system 502 provides various functions that enable a user to capture and augment (e.g., annotate or otherwise modify or edit) media content associated with a message.

A camera system 504 includes control software (e.g., in a camera application) that interacts with and controls camera hardware (e.g., directly or via operating system controls) of the user system 402 to modify and augment real-time images captured and displayed via the interaction client 404.

The augmentation system 506 provides functions related to the generation and publishing of augmentations (e.g., media overlays) for images captured in real-time by cameras of the user system 402 or retrieved from memory of the user system 402. For example, the augmentation system 506 operatively selects, presents, and displays media overlays (e.g., an image filter or an image lens) to the interaction client 404 for the augmentation of real-time images received via the camera system 504 or stored images retrieved from memory 1202 of a user system 402. These augmentations are selected by the augmentation system 506 and presented to a user of an interaction client 404, based on a number of inputs and data, such as for example:
Geolocation of the user system 402; and
Entity relationship information of the user of the user system 402.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 402 for communication in a message, or applied to video content, such as a video content stream or feed transmitted from an interaction client 404. As such, the image processing system 502 may interact with, and support, the various subsystems of the communication system 508, such as the messaging system 510 and the video communication system 512.

A media overlay may include text or image data that can be overlaid on top of a photograph taken by the user system 402 or a video stream produced by the user system 402. In some examples, the media overlay may be a location overlay (e.g., Venice beach), a name of a live event, or a name of a merchant overlay (e.g., Beach Coffee House). In further examples, the image processing system 502 uses the geolocation of the user system 402 to identify a media overlay that includes the name of a merchant at the geolocation of the user system 402. The media overlay may include other indicia associated with the merchant. The media overlays may be stored in the databases 428 and accessed through the database server 426.

The image processing system 502 provides a user-based publication platform that enables users to select a geolocation on a map and upload content associated with the selected geolocation. The user may also specify circumstances under which a particular media overlay should be offered to other users. The image processing system 502 generates a media overlay that includes the uploaded content and associates the uploaded content with the selected geolocation.

The augmentation creation system 514 supports augmented reality developer platforms and includes an application for content creators (e.g., artists and developers) to create and publish augmentations (e.g., augmented reality experiences) of the interaction client 404. The augmentation creation system 514 provides a library of built-in features and tools to content creators including, for example custom shaders, tracking technology, and templates.

In some examples, the augmentation creation system 514 provides a merchant-based publication platform that enables merchants to select a particular augmentation associated with a geolocation via a bidding process. For example, the augmentation creation system 514 associates a media overlay of the highest bidding merchant with a corresponding geolocation for a predefined amount of time.

A communication system 508 is responsible for enabling and processing multiple forms of communication and interaction within the interaction system 400 and includes a messaging system 510, an audio communication system 516, and a video communication system 512. The messaging system 510 is responsible for enforcing the temporary or time-limited access to content by the interaction clients 404. The messaging system 510 incorporates multiple timers (e.g., within an ephemeral timer system) that, based on duration and display parameters associated with a message or collection of messages (e.g., a story), selectively enable access (e.g., for presentation and display) to messages and associated content via the interaction client 404. The audio communication system 516 enables and supports audio communications (e.g., real-time audio chat) between multiple interaction clients 404. Similarly, the video communication system 512 enables and supports video communications (e.g., real-time video chat) between multiple interaction clients 404.

A user management system 518 is operationally responsible for the management of user data and profiles, and maintains entity information (e.g., stored in entity tables 608, entity graphs 610 and profile data 602) regarding users and relationships between users of the interaction system 400.

A collection management system 520 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 520 may also be responsible for publishing an icon that provides notification of a particular collection to the user interface of the interaction client 404. The collection management system 520 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 520 employs machine vision (or image recognition technology) and content rules to curate a content collection automatically. In certain examples, compensation may be paid to a user to include user-generated content into a collection. In such cases, the collection management system 520 operates to automatically make payments to such users to use their content.

A map system 522 provides various geographic location (e.g., geolocation) functions and supports the presentation of map-based media content and messages by the interaction client 404. For example, the map system 522 enables the display of user icons or avatars (e.g., stored in profile data 602) on a map to indicate a current or past location of “friends” of a user, as well as media content (e.g., collections of messages including photographs and videos) generated by such friends, within the context of a map. For example, a message posted by a user to the interaction system 400 from a specific geographic location may be displayed within the context of a map at that particular location to “friends” of a specific user on a map interface of the interaction client 404. A user can furthermore share his or her location and status information (e.g., using an appropriate status avatar) with other users of the interaction system 400 via the interaction client 404, with this location and status information being similarly displayed within the context of a map interface of the interaction client 404 to selected users.

A game system 524 provides various gaming functions within the context of the interaction client 404. The interaction client 404 provides a game interface providing a list of available games that can be launched by a user within the context of the interaction client 404 and played with other users of the interaction system 400. The interaction system 400 further enables a particular user to invite other users to participate in the play of a specific game by issuing invitations to such other users from the interaction client 404. The interaction client 404 also supports audio, video, and text messaging (e.g., chats) within the context of gameplay, provides a leaderboard for the games, and also supports the provision of in-game rewards (e.g., coins and items).

An external resource system 526 provides an interface for the interaction client 404 to communicate with remote servers (e.g., third-party servers 412) to launch or access external resources, i.e., applications or applets. Each third-party server 412 hosts, for example, a markup language (e.g., HTML5) based application or a small-scale version of an application (e.g., game, utility, payment, or ride-sharing application). The interaction client 404 may launch a web-based resource (e.g., application) by accessing the HTML5 file from the third-party servers 412 associated with the web-based resource. Applications hosted by third-party servers 412 are programmed in JavaScript leveraging a Software Development Kit (SDK) provided by the interaction servers 424. The SDK includes APIs with functions that can be called or invoked by the web-based application. The interaction servers 424 hosts a JavaScript library that provides a given external resource access to specific user data of the interaction client 404. HTML5 is an example of technology for programming games, but applications and resources programmed based on other technologies can be used.

To integrate the functions of the SDK into the web-based resource, the SDK is downloaded by the third-party server 412 from the interaction servers 424 or is otherwise received by the third-party server 412. Once downloaded or received, the SDK is included as part of the application code of a web-based external resource. The code of the web-based resource can then call or invoke certain functions of the SDK to integrate features of the interaction client 404 into the web-based resource.

The SDK stored on the interaction server system 410 effectively provides the bridge between an external resource (e.g., applications 406 or applets) and the interaction client 404. This gives the user a seamless experience of communicating with other users on the interaction client 404 while also preserving the look and feel of the interaction client 404. To bridge communications between an external resource and an interaction client 404, the SDK facilitates communication between third-party servers 412 and the interaction client 404. A bridge script running on a user system 402 establishes two one-way communication channels between an external resource and the interaction client 404. Messages are sent between the external resource and the interaction client 404 via these communication channels asynchronously. Each SDK function invocation is sent as a message and callback. Each SDK function is implemented by constructing a unique callback identifier and sending a message with that callback identifier.

By using the SDK, not all information from the interaction client 404 is shared with third-party servers 412. The SDK limits which information is shared based on the needs of the external resource. Each third-party server 412 provides an HTML5 file corresponding to the web-based external resource to interaction servers 424. The interaction servers 424 can add a visual representation (such as a box art or other graphic) of the web-based external resource in the interaction client 404. Once the user selects the visual representation or instructs the interaction client 404 through a graphical user interface (GUI) of the interaction client 404 to access features of the web-based external resource, the interaction client 404 obtains the HTML5 file and instantiates the resources to access the features of the web-based external resource.

The interaction client 404 presents a graphical user interface (e.g., a landing page or title screen) for an external resource. During, before, or after presenting the landing page or title screen, the interaction client 404 determines whether the launched external resource has been previously authorized to access user data of the interaction client 404. In response to determining that the launched external resource has been previously authorized to access user data of the interaction client 404, the interaction client 404 presents another graphical user interface of the external resource that includes functions and features of the external resource. In response to determining that the launched external resource has not been previously authorized to access user data of the interaction client 404, after a threshold period of time (e.g., 3 seconds) of displaying the landing page or title screen of the external resource, the interaction client 404 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 404 adds the external resource to a list of authorized external resources and allows the external resource to access user data from the interaction client 404. The external resource is authorized by the interaction client 404 to access the user data under an OAuth 2 framework.

The interaction client 404 controls the type of user data that is shared with external resources based on the type of external resource being authorized. For example, external resources that include full-scale applications (e.g., an application 406) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 528 operationally enables the purchasing of advertisements by third parties for presentation to end-users via the interaction clients 404 and also handles the delivery and presentation of these advertisements.

An artificial intelligence and machine learning system 230 provides a variety of services to different subsystems within the interaction system 400. For example, the artificial intelligence and machine learning system 530 operates with the image processing system 502 and the camera system 504 to analyze images and extract information such as objects, text, or faces. This information can then be used by the image processing system 502 to enhance, filter, or manipulate images. The artificial intelligence and machine learning system 530 may be used by the augmentation system 506 to generate augmented content and augmented reality experiences, such as adding virtual objects or animations to real-world images. The communication system 508 and messaging system 510 may use the artificial intelligence and machine learning system 530 to analyze communication patterns and provide insights into how users interact with each other and provide intelligent message classification and tagging, such as categorizing messages based on sentiment or topic. The artificial intelligence and machine learning system 530 may also provide chatbot functionality to message interactions 420 between user systems 402 and between a user system 402 and the interaction server system 410. The artificial intelligence and machine learning system 530 may also work with the audio communication system 516 to provide speech recognition and natural language processing capabilities, allowing users to interact with the interaction system 400 using voice commands.

### Data Architecture

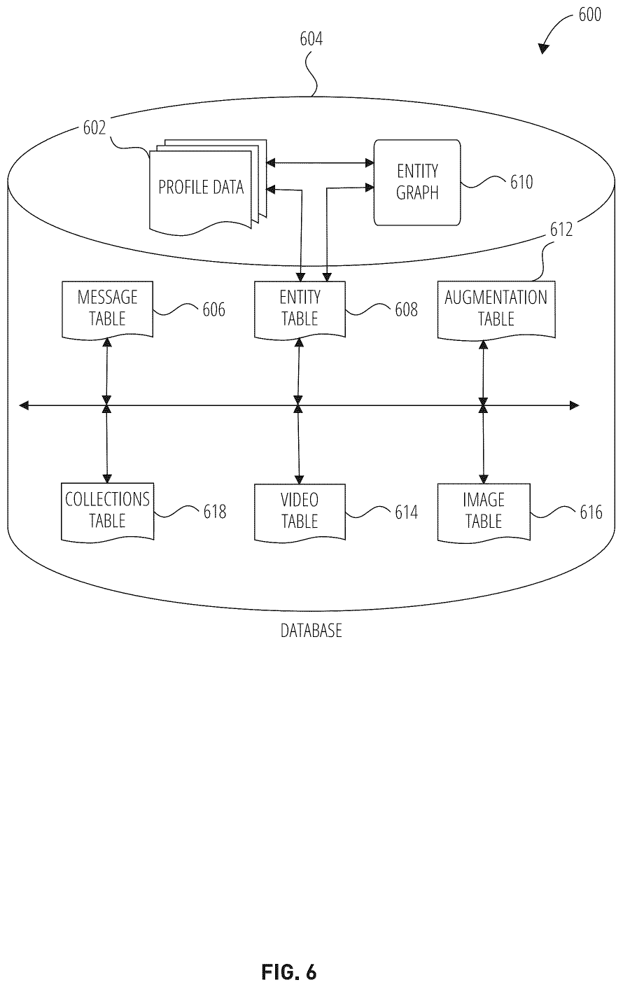

FIG. 6 is a schematic diagram illustrating data structures 600, which may be stored in the database 604 of the interaction server system 410, according to certain examples. While the content of the database 604 is shown to comprise multiple tables, it will be appreciated that the data could be stored in other types of data structures (e.g., as an object-oriented database). In some cases, the database 604 includes features of or corresponds to database 428 in FIG. 4, and/or vice versa.

The database 604 includes message data stored within a message table 606. This message data includes, for any particular message, at least message sender data, message recipient (or receiver) data, and a payload. Further details regarding information that may be included in a message and included within the message data stored in the message table 606, are described below with reference to FIG. 6.

An entity table 608 stores entity data, and is linked (e.g., referentially) to an entity graph 610 and profile data 602. Entities for which records are maintained within the entity table 608 may include individuals, corporate entities, organizations, objects, places, events, and so forth. Regardless of entity type, any entity regarding which the interaction server system 410 stores data may be a recognized entity. Each entity is provided with a unique identifier, as well as an entity type identifier (not shown).

The entity graph 610 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 400. A friend relationship can be established by mutual agreement between two entities. This mutual agreement may be established by an offer from a first entity to a second entity to establish a friend relationship, and acceptance by the second entity of the offer for establishment of the friend relationship.

Where the entity is a group, the profile data 602 for the group may similarly include one or more avatar representations associated with the group, in addition to the group name, members, and various settings (e.g., notifications) for the relevant group.

The database 604 also stores augmentation data, such as overlays or filters, in an augmentation table 612. The augmentation data is associated with and applied to videos (for which data is stored in a video table 614) and images (for which data is stored in an image table 616).

Filters, in some examples, are overlays that are displayed as overlaid on an image or video during presentation to a recipient user. Filters may be of various types, including user-selected filters from a set of filters presented to a sending user by the interaction client 404 when the sending user is composing a message. Other types of filters include geolocation filters (also known as geo-filters), which may be presented to a sending user based on geographic location. For example, geolocation filters specific to a neighborhood or special location may be presented within a user interface by the interaction client 404, based on geolocation information determined by a Global Positioning System (GPS) unit of the user system 402.

Another type of filter is a data filter, which may be selectively presented to a sending user by the interaction client 404 based on other inputs or information gathered by the user system 402 during the message creation process. Examples of data filters include current temperature at a specific location, a current speed at which a sending user is traveling, battery life for a user system 402, or the current time.

Other augmentation data that may be stored within the image table 616 includes augmented reality content items (e.g., corresponding to applying “lenses” or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of the user system 402 and then displayed on a screen of the user system 402 with the modifications. This also includes modifications to stored content, such as video clips in a collection or group that may be modified. For example, in a user system 402 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 402 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudo random animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated. Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation. In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

The system can capture an image or video stream on a client device (e.g., the user system 402) and perform complex image manipulations locally on the user system 402 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 402.

In some examples, the system operating within the interaction client 404 determines the presence of a face within the image or video stream and provides modification icons associated with a computer animation model to transform image data, or the computer animation model can be present as associated with an interface described herein. The system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

A collections table 618 stores data regarding collections of messages and associated image, video, or audio data, which are compiled into a collection (e.g., a story or a gallery). The creation of a particular collection may be initiated by a particular user (e.g., each user for which a record is maintained in the entity table 608). A user may create a “personal story” in the form of a collection of content that has been created and sent/broadcast by that user. To this end, the user interface of the interaction client 404 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 404, to contribute content to a particular live story. The live story may be identified to the user by the interaction client 404, based on his or her location. The end result is a “live story” told from a community perspective.

A further type of content collection is known as a “location story,” which enables a user whose user system 402 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 614 stores video data that, in some examples, is associated with messages for which records are maintained within the message table 606. Similarly, the image table 616 stores image data associated with messages for which message data is stored in the entity table 608. The entity table 608 may associate various augmentations from the augmentation table 612 with various images and videos stored in the image table 616 and the video table 614.

### Generation of Metric Depth Estimation

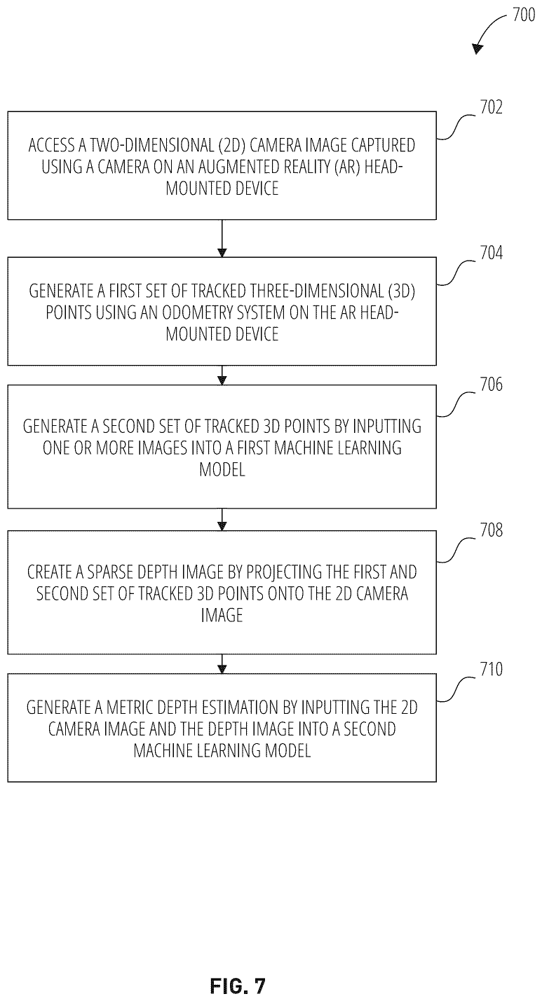

FIG. 7 illustrates an example method 700 for generating metric depth estimation, according to some examples. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

FIG. 7 is described as being performed by certain systems or applying certain processes, such as a particular machine learning model or computer vision model, but the processes described herein can be performed by one or more other or the same machine learning models, computer vision models, or a combination thereof.

Extended Reality (XR) is an umbrella term encapsulating Augmented Reality (AR), Virtual Reality (VR), Mixed Reality (MR), and everything in between. For the sake of simplicity, examples are described using one type of system, such as XR or AR. However, it is appreciated that other types of systems apply.

At operation 702, the interaction system accesses a two-dimensional (2D) camera image captured using a camera on an augmented reality (AR) head-mounted device. The interaction system captures 2D images reflecting the user's current view of the real world, which the AR system augments with virtual elements.

The camera used is integrated into the head-mounted device, designed to capture wide-angle views that align closely with the human field of view, thereby enhancing the immersive experience.

The use of a camera specifically tailored for AR applications means that the image can include a variety of environmental details-ranging from nearby objects to distant landscapes. This richness in visual data allows for more effective and nuanced depth perception when processed.

The 2D image is used by the interaction system to understand and interact with the three-dimensional structure of the environment. The image data serves as a reference point against which other sensory and tracking data are synchronized and interpreted, facilitating the creation of a cohesive and interactive augmented space.

The features described herein refer to the use of one image. However, it is appreciated that features described herein can use multiple images, and vice versa. Moreover, features are described based on images from one camera. However, it is appreciated that such features can use images from a plurality of cameras, and/or vice versa.

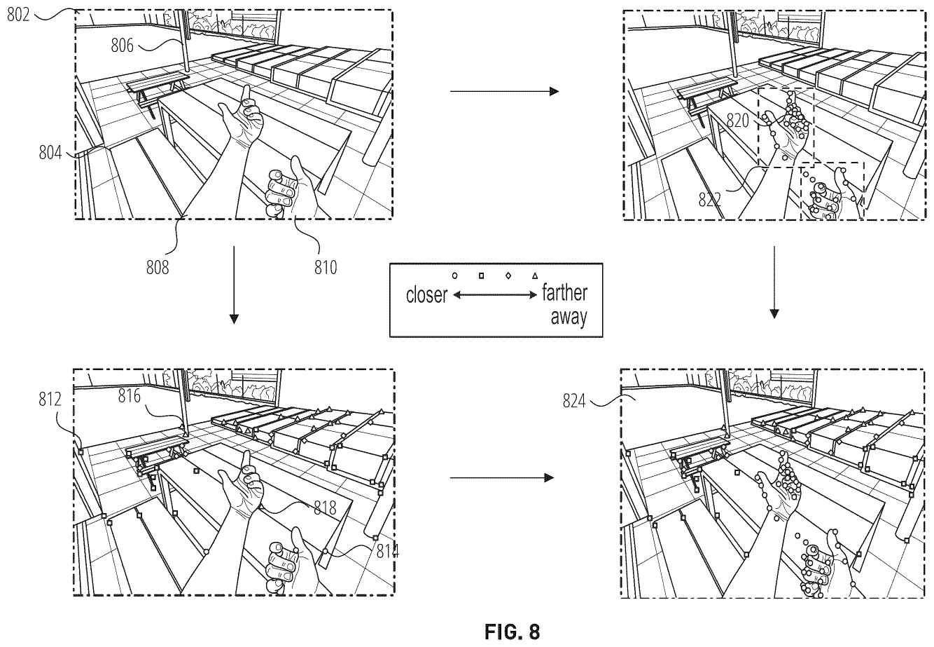

FIG. 8 illustrates an example of generating three dimensional points that are tracked by one or more algorithms, according to some examples. The interaction system can capture a 2D image 802 from a camera on the AR system.

The interaction system can use a 2D camera image from a monocular camera. While the image can be in grayscale, it is appreciated that the image can include a color image.

Grayscale images may only include intensity information, which simplifies the processing load on the AR system. This can be advantageous in scenarios where computational resources are limited or when high-speed image processing is crucial. In depth estimation, intensity gradients in grayscale images can be sufficient to identify features and changes in a scene, which are essential for tasks like feature tracking and motion detection.

Color images provide additional data that can be used for more sophisticated image processing tasks. The use of color can improve the detection and differentiation of features within the scene, especially in complex environments where color cues help distinguish between objects that might otherwise appear similar in grayscale. For AR applications, color adds a layer of realism and can be used to enhance the user's experience by providing a more vivid and engaging interaction with augmented elements.

In some cases, color data is used not just for visual fidelity but also for functional purposes such as object recognition, scene segmentation, and more advanced depth inference methods that leverage color consistency across different viewpoints.

At operation 704, the interaction system generates a first set of tracked three-dimensional (3D) points using an odometry system on the AR head-mounted device. The interaction system applies an odometry system integrated into the augmented reality (AR) head-mounted device.

The interaction system tracks the spatial movement of the device through its environment, capturing the 3D coordinates of specific points in space as the user moves. The odometry system in an AR device can use a combination of sensors and computational methods to track movement and orientation.

In some cases, the interaction system uses Visual Odometry (VO) by using the camera itself to capture sequential images and then employs one or more computer vision techniques to estimate the device's motion based on changes observed in these images. By identifying common features or landmarks in successive frames, the system can infer the relative motion of the camera—and hence the device-across frames.

In some cases, the interaction system uses an Inertial Measurement Units (IMUs) that includes one or more accelerometers and gyroscopes that measure acceleration and rotational changes, respectively. The IMU data is used by the interaction system to receive real-time updates on the device's orientation and acceleration, which are used in the calculation of changes in position over time.

In some cases, the interaction system uses a combination of data from visual and inertial sources, such as via Visual-Inertial Odometry (VIO). This combination allows for more accurate and robust tracking, compensating for the individual weaknesses of each method (e.g., visual occlusions or IMU drift).

The tracked 3D points are generated by the odometry system. The system identifies distinct features in the environment that can be easily tracked across multiple images or sensor readings. These features could be edges, corners, or other notable visual markers.

As the device moves, the system continues to monitor these features, updating their positions in 3D space relative to the movement of the device. This tracking can be performed by projecting the detected features back into a 3D space using the known parameters of the camera (like its focal length and sensor characteristics) and the motion data from the IMU.

The culmination of tracking multiple points across the device's trajectory results in the formation of a “point cloud,” which represents the spatial layout of the environment in three dimensions. Each point in this cloud has associated 3D coordinates that correspond to a real-world position relative to the device's starting location.

The generation of the first set of tracked 3D points by an odometry system in augmented reality (AR) devices can be optimized for specific detection ranges-such as far-field, mid-field, or near-field—depending on the intended application and environmental context.

For instance, the odometry system can be fine-tuned for far-field detection by leveraging high-resolution cameras or specialized optical zoom functionalities to accurately track features or objects located at significant distances. This is particularly useful in outdoor AR applications, such as navigation aids or architectural visualization, where understanding distant features is crucial for accurate spatial analysis and user interaction.

Conversely, the odometry system can be optimized for mid-field or near-field point detection focus on more immediate surroundings. Mid-field optimized systems may employ monocular cameras that provide a good balance between field of view and detail at intermediate distances, suitable for applications like interactive gaming or retail shopping experiences.

Near-field detection, useful for close-up interactions such as virtual object manipulation or detailed inspection tasks, may use additional sensors like depth cameras or structured light systems. These systems can provide dense, accurate depth information at close range, allowing for precise tracking and interaction with objects within arm's reach. By adjusting the focus and sensitivity of the tracking system to specific fields, AR devices can enhance performance and utility across a broad range of environments and use cases.

In some cases, the odometry system is optimized for static object detection, focusing on accuracy and detail in environments where objects do not move, such as benches 804 and pillars 806. The first machine learning model can be optimized for moving object detection, such as a user's left arm 808 or right arm 810.

In some cases, the odometry system is optimized for lighting conditions, such as adjusting exposure control and dynamic range to handle bright environments effectively, avoiding glare and preserving detail.

In some cases, the odometry system is optimized for cluttered environments, such as optimizing for scenes with many overlapping elements, using advanced segmentation and depth prioritization to maintain accurate object recognition and tracking. In some cases, the odometry system is optimized for sparse environments, tailored to work efficiently in minimalistic settings where fewer cues are available, relying more on geometric shapes and less on texture details.

In some cases, the odometry system is optimized for large object tracking by adapting to effectively manage and interact with large-scale objects or structures, useful in, for example, construction AR or large machinery interaction. In some cases, the odometry system is optimized for small object precision, such as by enhancing precision for tracking and interacting with small objects, important in medical AR applications or detailed craftwork.

In some cases, the odometry system is optimized for user interaction levels, can include passive interaction where users primarily observe or receive information without much direct manipulation, optimizing for viewing angles and information display. In some cases, the odometry system is optimized for active interaction requiring frequent and detailed user input, enhancing responsiveness and interaction feedback mechanisms.

In some cases, the odometry system is optimized for computational load, such as a high-performance mode that is optimized for devices with substantial processing power, allowing for complex calculations and high-resolution imaging. In some cases, the odometry system is optimized for energy-saving mode, fine-tuning for energy efficiency, suitable for longer usage on battery-operated devices, compromising slightly on processing speed or detail.

Although examples described herein explain certain systems for certain functions (e.g., the odometry system for near field), it is appreciated that such systems can be applied for other functions and vice versa (e.g., odometry system for static objects, first machine learning model for near field).

FIG. 8 illustrates the generation of the first set of tracked 3D points 812 of the camera image. The system focuses on tracking points around static objects such as corners of a table or pillars, which provide reliable and fixed reference points for spatial mapping and depth estimation. These static points anchor the virtual content within the real-world environment, ensuring that augmented objects maintain their position relative to these fixed structures as the user moves around.

Simultaneously, the system identifies and tracks 3D points associated with moving objects, such as human hands. As shown, the 3D point 816 of the pillar is indicated as being far from the AR device, and the 3D point 814 of the table is considered to be close to the AR device.

When tracking both static objects such as the table and dynamic objects such as the moving hand, errors can occur due to the way these elements interact visually within the camera's field of view.

In this specific instance of FIG. 8, the algorithm encounters an issue where a perceived ‘corner’ is created at the point where the moving hand intersects with the edge of the table in the camera's image (e.g., 3D point 818). The algorithm, designed to track 3D points and estimate their depth relative to the AR device, mistakenly interprets this visual corner as a single point located at a significant distance. This misinterpretation can be due to the overlapping of visual cues in the 2D camera image, which can confuse the depth estimation model. In some cases, the misinterpretation can be that the metric distance estimate of a point is incorrect, due to one of several reasons (e.g., trying to track a point along an edge where it cannot accurately be triangulated from two views).

When the hand moves close to the edges of the table, the camera captures both elements (hand and table edge) in close proximity. If the hand partially occludes the table or aligns closely with its edge, the algorithm may generate a new ‘corner’ where none physically exists. This is a visual artifact created by the alignment of different depths in the 2D image.

Since the algorithm relies on extracting depth information from visual data, the odometry system can be misled by such alignments. Typically, corners are reliable indicators of depth changes; however, when created by moving objects, they can lead to inaccuracies. The algorithm may assign the depth value of the farther object (the table) to the ‘corner’ created by the hand, or it could erroneously calculate a compounded depth based on the merging of visual data from both the hand and the table.

As a result, this misidentified corner is perceived to be at a far distance, much farther than both the actual distance of the table and certainly the hand. This kind of error not only impacts the accuracy of the depth map but can also affect the AR application's ability to correctly place virtual objects in relation to real-world objects. For interactive applications where precision is crucial, such as in AR-based tools used for education, design, or precision tasks, these errors can diminish the user experience and effectiveness of the application.

At operation 706, the interaction system generates a second set of tracked 3D points by inputting one or more images captured using the camera into a first machine learning model. The interaction system applies the machine learning model that is trained to understand and interact with human hands within the user's immediate environment.

One or more images captured by the device's camera are inputted into a specialized machine learning model, which is explicitly designed as a hand tracker. The hand tracker is a type of machine learning model that is specifically trained to recognize and track human hands and their joints. In some cases, the system can predict a hand position, motion, joint location, or other characteristic of a hand from past frames and motion at the current frame, such as via a machine learning model or other model described herein.

Training data for this model can include of numerous images of hands in various positions, gestures, and lighting conditions, augmented with 3D joint annotations. These datasets may include synthetic images generated using 3D modeling software, providing a comprehensive range of hand positions and orientations to ensure robustness and accuracy.

When an image or sequence of images from the AR device's camera is inputted into this model, the model processes these images to detect the presence of hands and then identifies specific points or ‘landmarks’ on the hands, such as fingertips, knuckles, and joints. In some cases, the system estimates a distance, such as distance estimates of the hands and objects. In some cases, the system generates a mesh or other three dimensional representation. Although examples described herein apply 3D points, it is appreciated that the features described herein can also be applied to a mesh.

The model uses its learned features to estimate the 3D coordinates of these points relative to the camera. This involves not only recognizing the hand's shape and size but also inferring its orientation and depth from the camera's perspective.

The images used by the first machine learning model can be either the same as or different from those used by the odometry system. In some cases, the images used by the first machine learning model can be a subset of the images used by the odometry system, and/or vice versa.

Using the same images for both hand tracking and odometry minimizes the need for additional images, which can reduce the cost and power consumption of the device. When both functionalities rely on the same image feed, the interaction system can synchronize the data between the visual data and the algorithms, ensuring that the data used across different system components and algorithms are consistent.

In some cases, the odometry and hand tracking have different requirements, such as image resolution and field of view. For example, odometry may benefit from a wider field of view to capture more of the environment for better movement tracking, while hand tracking may require higher resolution to accurately discern detailed movements and gestures. As such, in some cases, the odometry and first machine learning model uses a different set of images.

In some cases, using different images allows each system to optimize its camera settings and processing algorithms according to its specific needs. For instance, the odometry system may use a camera set for a wide field of view to capture extensive environmental data, while the hand tracker might use a high-resolution camera focused on the area directly in front of the user.

Some systems may include specialized imaging hardware for hand tracking, such as depth sensors or infrared cameras, which provide data that is more conducive to recognizing and interpreting complex hand gestures than the visual cameras typically used for odometry.

As shown in FIG. 8, the first machine learning model outputs 3D tracked points 820 for the hand. The interaction system can manage and refine the tracking of 3D points, particularly those associated with dynamic objects like hands, by using boundaries and/or filtering.

The first machine learning model processes images captured by the camera to detect and track hand joints. This model is specifically trained to recognize certain objects, such as parts of the hand (e.g., knuckles and fingertips), a body, other user hands, facial features, and/or the like, and to estimate their positions in 3D space.

Once the hand joints are identified and their 3D coordinates estimated, the system generates a boundary, such as a bounding box 822, that includes or encompasses these points. The bounding box can be a rectangular or cubic region that includes some or all the tracked points of the hand.

The dimensions and position of the bounding box can be dynamically determined based on the extremities of the detected hand joints and their motion pattern. This allows the bounding box to adjust in real-time to movements and changes in the orientation of the hand.

The system assesses the first set of 3D points from the odometry system to identify 3D points on and around the hand using the bounding box. The system evaluates each point in the first set of 3D tracked points to determine whether any of the points fall within the bounding box around the hand. If a point lies within this boundary, this point is flagged as potentially erroneous or less reliable due to the dynamic nature of the hand and the potential for visual overlap or occlusion errors.

In some cases, the points within the boundary that are deemed erroneous or likely to cause confusion in depth or position interpretation are removed from the first set of tracked points. This cleanup helps prevent inaccuracies in the AR system's interpretation of the scene, especially those that might misrepresent the interaction between the hand and other elements.

In some cases, the more accurately detected and tracked 3D points of the hand joints from the first machine learning model are then added to the overall set of tracked points to generate a third set of tracked 3D points 824. These points are specifically from the hand tracker and are thus considered more reliable for representing the hand's position and movement.

With the integration of these refined hand joint points, the system recalibrates its understanding of the hand's position in 3D space, improving the AR experience by accurately overlaying digital content related to or interacting with the user's hands.

This method of using bounding boxes for dynamic object tracking and point set refinement in AR systems significantly enhances the accuracy and reliability of 3D object tracking, particularly for interactive and fast-moving objects. By intelligently filtering and integrating data, the system ensures that the virtual and real elements of the AR environment are aligned with high fidelity, providing users with a seamless and engaging experience.

At operation 708, the interaction system creates sparse points (or potentially sparse points) by projecting the first and second set of tracked 3D points onto the 2D camera image. The interaction system projects the tracked 3D points from two distinct sets onto the 2D camera image to accurately map these 3D points onto the 2D plane of the camera's image sensor, forming a depth image where each pixel's value corresponds to its metric distance or sparse depth. In some cases, the depth image corresponds to a relative distance. In some cases, the 3D points are mapped to a 3D space. For example, the sparse points can be 3D points that may not need to be projected onto a 2D image, but such 3D points can be inputted into a machine learning model directly.

The first and second sets of tracked 3D points are collected from different sources or processes, such as the first set derived from an odometry system and the second set generated by the first machine learning model trained for hand joint point detection.

The interaction system uses camera parameters, such as the focal length (f), the optical center (cx, cy), and/or lens distortion parameters, to define the projection from 3D space to the 2D image plane. For example, the interaction system can apply a perspective projection formula. The 3D points (x, y, z) (x,y,z) are projected onto the 2D image using the perspective projection formula:

$${x}^{′} = {f}_{x} \cdot \frac{x}{z} + {c}_{x} {y}^{′} = {f}_{y} \cdot \frac{y}{z} + {c}_{y}$$

x′x′ and y′y′ are the pixel coordinates in the 2D image, fₓfx and f_{y}fy are the focal lengths along the x and y axes, and cₓcx and c_{y}cy are the coordinates of the optical center on the image. zz is the depth of the point from the camera.

Each projected point's z-coordinate (depth information) is mapped to a grayscale intensity or color scale in the depth image. The closer the point to the camera, the brighter (or alternatively, darker, depending on the chosen convention) the point appears in the depth image.

The spatial resolution of the depth image can match that of the 2D camera image. However, since only specific points are tracked, many pixels in the depth image may initially have undefined or incomplete depth values.

In some cases, the interaction system applies multi-view stereo reconstruction. When multiple images from different viewpoints are available, the interaction system applies multi-view stereo reconstruction to enhance depth estimation by analyzing the disparities and parallax between images to infer depth information, filling gaps between tracked points by triangulating the same point observed from different cameras.

In some cases, the interaction system applies photometric methods, such as photometric stereo which uses variations in lighting to infer depth by observing how the same point responds under different lighting conditions or shape-from-shading by analyzing changes in brightness and texture to estimate depth based on assumptions about light direction, surface properties, and shadows, providing additional data to supplement sparse depth points.

In some cases, the interaction system applies inference from semantic segmentation, where the system identifies and classifies different parts of the scene (like walls, floors, and furniture), which can help in assigning depth values based on typical object sizes and expected geometries. For example, knowing an object is a table provides information about its likely height and planar properties.

At operation 710, the interaction system generates a metric depth estimation by inputting the 2D camera image and the depth image into a second machine learning model. The interaction system uses a second machine learning model to analyze both the 2D camera image and the depth image created from previously tracked 3D points.

The second machine learning model can include a deep neural network, trained to convert sparse depth data and 2D image features into metric depth estimations. This model could be trained to be effective at handling spatial hierarchies and preserving important features across layers.

The model is trained on a dataset where each entry includes of a 2D image paired with its corresponding depth map. The interaction system adjusts the neural network's weights to minimize the difference between its predictions and the true metric depths provided in the training data, which helps the model learn to infer accurate metric depths from various visual and depth cues.

The model extracts features from the 2D camera image that are relevant for depth perception. These features can include edges, corners, textures, and color gradients, which help the model gauge the layout and distances of surfaces and objects in the scene.

In some cases, the model integrates the depth image, aligning the depth image with the features extracted from the 2D image to create a comprehensive understanding of the scene. This integration allows the model to refine its initial depth estimates based on the additional context provided by the 2D image.

The model can output a metric depth map where pixel values (such as each pixel value in the image) represents an absolute distance from the camera to the corresponding point in the scene, such as measured in meters or another unit of length. This metric depth map enables AR applications to place virtual objects and enable interaction accurately within the real world.

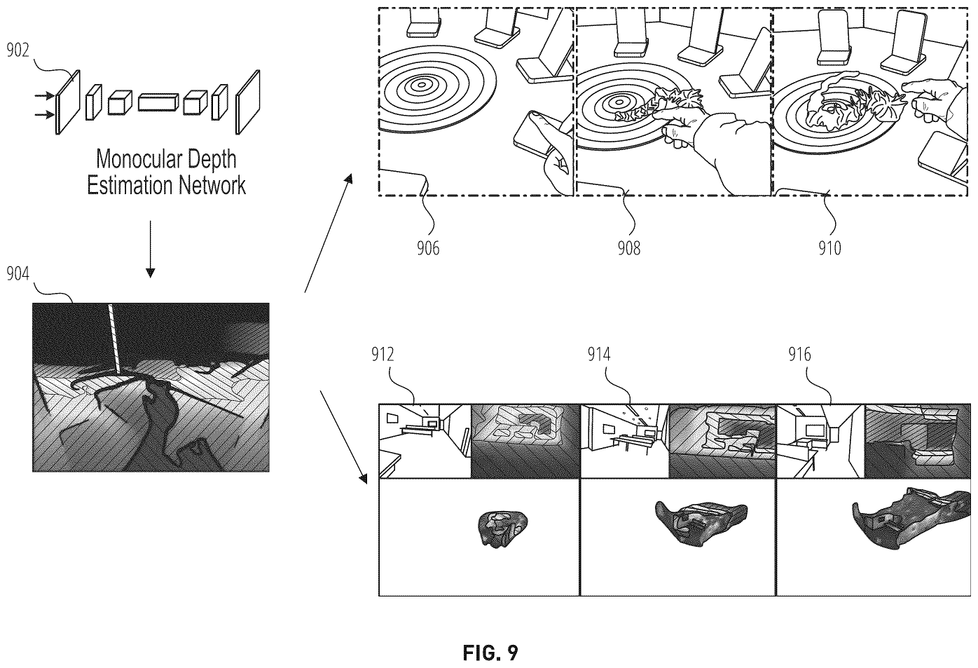

FIG. 9 illustrates the generation of metric depth according to some examples. FIG. 9 illustrates a monocular depth estimation network 902 that estimates depth from a single camera image. The monocular depth estimation network generates a relative depth map that shows the depth relationships within a scene—such as which objects are closer or further away relative to each other—but without specific distance measurements in real-world units (like meters). Although examples described herein explain the use of a sparse depth map or a relative depth map, it is appreciated that the features described herein can apply to either the sparse depth map or the relative depth map.

In some cases, the monocular depth estimation network is also be trained to provide metric depth maps. In some cases, a separate network or model is used to generate the metric depth maps. If the network is trained on data that includes absolute depth measurements (or if additional calibration and scaling techniques are used post-prediction), the network can output depths in absolute terms.

For metric depth capabilities, the network is trained explicitly with absolute depth measurements and/or fine-tuned with a calibration method that converts its relative depth predictions to metric scales, such as based on additional data or assumptions (such as average object sizes or specific camera setups). FIG. 9 illustrates the generation of the metric depth map 904 showing closeness of the hands and metric distances of other background objects.

With the metric depth map, the AR system can render virtual objects at precise depths, ensuring that they appear naturally integrated into the real environment. For example, a virtual chair can be rendered such that it appears to sit on the real floor rather than floating above it or sinking below it.

The three images 906, 908, and 910 in FIG. 9 each capture a progressive sequence in an augmented reality (AR) scenario, illustrating how metric depth estimation plays an important role in creating immersive and interactive experiences.

The first image 906 focuses solely on a hand, captured by the camera on an AR device. This image serves as the foundational visual input for depth estimation processes. The AR system identifies and tracks the hand's position and movements within the space as well as background objects and associated distances.

In the second image 908, the interaction system of the AR device leverages the metric depth information previously calculated to create an augmented reality effect, such as magic emanating from the hands. This effect uses the depth map to ensure that the visual effect of magic correctly originates from the exact location of the hand in three-dimensional space.

The metric depth helps in overlaying the magic effect precisely at the right depth, making the effect appear as if it is seamlessly emerging from the user's hand. This depth accuracy also ensures that the magic does not penetrate the background, enhancing the realism of the interaction and engaging the user more deeply.

The third image 910 continues the sequence, showing the magic extending further into the real world, interacting with other elements of the physical environment. Here, the metric depth map helps to maintain the consistency and trajectory of the magic as it moves away from the hand and interacts with other objects in the room. Whether the magic is designed to bounce off surfaces, wrap around objects, or float through the air, the depth information ensures that all these interactions respect the real-world spatial relationships.

The other sequence of images 912, 914, and 916 illustrates how the depth information can help to capture, process, and digitally reconstruct a real-world environment over time. Each image includes] three sub-images that together demonstrate the progression of scene understanding from raw camera input to a detailed virtual recreation.

The top left sub-image of the first image 912 shows the initial camera view of a person beginning to walk through a room. This sub-image captures the early stages of movement within a relatively static background, providing the first set of visual data from which the system begins to extract information.

The top right sub-image displays the initial depth map created from the camera image. This map illustrates the relative depths of various objects in the room, such as a person, furniture, and walls.

The bottom sub-image reveals the early stages of the 3D virtual scene recreation. At this point, the virtual model of the room includes only basic structures and key elements identified from the initial depth map. Details are sparse and general layout forms the foundation of the scene.

The top left sub-image of the second image 914 shows the camera view where the person is further along their path through the room, capturing new angles and perspectives of the environment. The top right sub-image corresponds to the depth map incorporating new data from the updated camera view. As the person moves, the system can capture depth information from different parts of the room and from different angles, enhancing the accuracy and resolution of the depth map.

The bottom sub-image shows the virtual scene recreation becoming more refined, with improvements in spatial accuracy and object detail. New elements that were not visible or were partially obscured in the first image are now beginning to be incorporated, filling out the virtual representation of the room.

In the third image 916, the top left sub-image shows the person nearing the completion of their walk through the room, with the camera capturing the full extent of the space. This comprehensive view enables final adjustments and captures in the data collection process.

The top right sub-image illustrates a depth map is now highly detailed, showing nuanced variations in depth across the room. The increased data from the camera's journey through the space allows for a much richer depth understanding, identifying small features and complex objects.

The bottom sub-image shows the virtual scene now more fully developed, displaying a detailed and accurate 3D recreation of the real environment. The system uses all of the collected data so far to render a complete digital model, where virtual objects are precisely placed according to their real-world locations and characteristics. This final recreation can be used for various applications, including virtual tours, interior design planning, or AR gaming.

When generating a depth map for scene reconstruction, especially in augmented reality (AR) or virtual reality (VR) environments, it is important to differentiate between static and dynamic elements within the scene. The objective is typically to reconstruct a stable, unchanging environment, which means that moving objects like hands or other transient elements can introduce noise or inaccuracies if included.

The interaction system filters out moving objects from a scene reconstruction by accurately detecting and identifying these elements. The interaction system can identify such elements by optical flow which measures the motion of objects between consecutive frames based on changes in pixel intensity, frame-to-frame disparity by comparing the depth values in sequential frames, machine learning models that are trained to recognize common moving objects, such as people or vehicles, based on their shape, size, and movement patterns, and/or the like.

Once potential moving objects are detected, the system segments 3D points from the static background by creating a mask or boundary around the identified objects. The interaction system can apply semantic segmentation that utilizes machine learning to classify parts of the image into categories (e.g., people, furniture, walls). This helps in not only detecting but also understanding what each part of the image represents, allowing for more precise exclusion of moving objects. In some cases, the interaction system applies object tracking, where in scenarios where objects need to be tracked over time, the system may use trackers to maintain location information on identified moving objects across frames.

With the dynamic objects identified and segmented, the interaction system excludes such objects from the depth data used for constructing the virtual environment. The areas identified as containing moving objects are either not included in the final depth map or are filled using data from surrounding static areas. If small portions of moving objects are detected, interpolation from surrounding static depth data can smooth over these regions, preventing their inclusion in the final reconstructed scene. The system then reconstructs the static parts of the environment.

### 3D Point Removal and Replacement

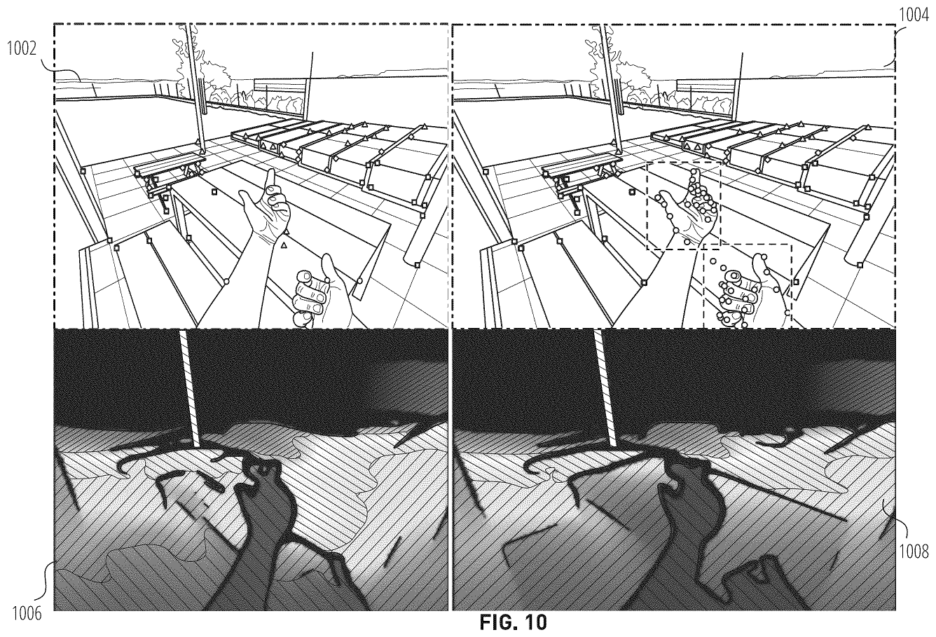

FIG. 10 illustrates the improvement of the interaction system using 3D point removal and replacement, according to some examples. These images illustrate how the interaction system corrects depth map errors caused by erroneous tracked points.

The top left image 1002 shows an image that captures the initial set of 3D tracked points generated by the odometry system. These points map out the static parts of the environment, like furniture and architectural features. However, an erroneous point appears where the hand is near the table, such as an error caused by the motion of the hand or overlapping visual data leading to incorrect depth estimation. The presence of this erroneous point suggests a misinterpretation of the scene's spatial layout by the odometry system, typical in scenarios where dynamic and static elements interact closely.

The bottom left image 1006 illustrates the impact to the depth map. This image shows the resulting depth map generated using the initial tracked points, including the erroneous point. Because of this incorrect point, the depth map inaccurately represents the table's depth, potentially showing it as being further away or distorted compared to its actual position.

The top right image 1004 shows an image that displays the re-evaluated scene where the erroneous point detected by the odometry system near the hand and table is removed. The system applies a boundary around the hand (such as using the machine learning model trained for dynamic objects like hands) to identify and exclude the incorrect point.

The boundary acts as a filter to differentiate between reliable static points and potentially erroneous points influenced by the hand's movement. After removing the inappropriate point, the system supplements the tracked points with more accurate data from the machine learning model, which is specifically trained to handle dynamic objects such as hands.

The bottom right image 1008 shows the improved depth map after applying your invention. With the erroneous point removed and replaced by more accurate tracking from the machine learning model, the depth representation of the table is now much more accurate and true to its real-world positioning.

The embodiments described herein can handle scenarios where hands or other objects are partially occluded, such as when one hand is behind another in the user's view. Understanding and managing these occlusions can help when creating realistic and interactive AR experiences.

When parts of a hand (such as the palm of the left hand) are occluded but other parts (like fingers and forearm) are visible, the system can use predictive modeling to infer the position of hidden joints. The system can apply a machine learning model that is trained on a wide range of hand positions and orientations. The model can predict the likely positions of occluded joints based on the visible parts of the hand and the typical anatomical structure of hands.

The system can use depth sensors or depth estimation algorithms to help distinguish between the foreground hand (right hand) and the background hand (left hand). By analyzing depth values, the system can determine which parts of the hand are closer to the viewer and use this information to model the position of occluded joints accurately.

If the hands were previously fully visible before one occluded the other, the system could use historical motion data (captured in earlier frames) to predict the current position of the occluded hand's joints.

When deciding whether to remove occluded hand data, the system can use depth information to identify which hand is in front (and thus fully visible) and which is occluded. If the distance between the hands is sufficient to clearly distinguish them, the system may opt to filter out the joints of the occluded hand to avoid inaccuracies in depth mapping or interactive functions.

The system can implement visibility thresholds, where joints or parts of the hand must meet a minimum visibility criterion to be included in tracking and interaction calculations. This helps in maintaining the integrity of the interaction model by excluding highly uncertain data.

In scenarios where hand occlusion is frequent or highly variable, the system may dynamically choose which hand to track based on a set of predefined criteria, such as which hand is more central in the view, which hand is performing a task, or which hand has higher visibility over time.

In some cases, the interaction system applies a global scale correction to the estimated metric depth to ensure the accuracy and realism of the virtual elements overlaid on real-world scenes. The interaction system adjusts the depth values generated by a neural network so that the depth values match the actual scale of the physical environment.

Depth estimation models can sometimes produce depth values that are accurate in relative terms but not correctly scaled to real-world units (like meters). This discrepancy can arise due to various factors, including training data limitations, model biases, or intrinsic camera parameters not being fully accounted for during the depth estimation process.

In some cases, the interaction system uses a neural network to estimate the depth of various points in a scene from a 2D image. This network may have been trained on a dataset where the true depth values are known, but due to differences in camera configurations, scene compositions, or other factors, the output depth values might not be correctly scaled.

In some cases, the interaction system applies a global scale correction. The system first determines reference points whose true depths are known or can be accurately measured. These reference points could be specific objects or features in the environment whose sizes and distances are predefined or can be measured using certain features such as LiDAR, stereo cameras, or manual input.

The depths estimated by the neural network for these reference points are compared to their true or measured depths. This comparison reveals the scale factor or the ratio of the estimated depth to the true depth.

The interaction system applies a global scale factor based on the average discrepancy observed across all reference points. For instance, if the neural network consistently estimates depths that are twice as large as they should be, the global scale factor would be 0.5.

The global scale factor is then applied to all the depth values estimated by the neural network across the scene to adjust the estimated depths to align with the actual scales of the scene, ensuring that the metric depths used in the AR system are realistic and consistent with the physical environment.

### Data Communications Architecture

FIG. 11 is a schematic diagram illustrating a structure of a message 1100, according to some examples, generated by an interaction client 404 for communication to a further interaction client 404 via the interaction servers 424. The content of a particular message 1100 is used to populate the message table 606 stored within the database 604, accessible by the interaction servers 424. Similarly, the content of a message 1100 is stored in memory as “in-transit” or “in-flight” data of the user system 402 or the interaction servers 424. A message 1100 is shown to include the following example components:
Message identifier 1102: a unique identifier that identifies the message 1100.
Message text payload 1104: text, to be generated by a user via a user interface of the user system 402, and that is included in the message 1100.
Message image payload 1106: image data, captured by a camera component of a user system 402 or retrieved from a memory component of a user system 402, and that is included in the message 1100. Image data for a sent or received message 1100 may be stored in the image table 616.
Message video payload 1108: video data, captured by a camera component or retrieved from a memory component of the user system 402, and that is included in the message 1100. Video data for a sent or received message 1100 may be stored in the image table 616.
Message audio payload 1110: audio data, captured by a microphone or retrieved from a memory component of the user system 402, and that is included in the message 1100.
Message augmentation data 1112: augmentation data (e.g., filters, stickers, or other annotations or enhancements) that represents augmentations to be applied to message image payload 1106, message video payload 1108, or message audio payload 1110 of the message 1100. Augmentation data for a sent or received message 1100 may be stored in the augmentation table 612.
Message duration parameter 1114: parameter value indicating, in seconds, the amount of time for which content of the message (e.g., the message image payload 1106, message video payload 1108, message audio payload 1110) is to be presented or made accessible to a user via the interaction client 404.
Message geolocation parameter 1116: geolocation data (e.g., latitudinal and longitudinal coordinates) associated with the content payload of the message. Multiple message geolocation parameter 1116 values may be included in the payload, each of these parameter values being associated with respect to content items included in the content (e.g., a specific image within the message image payload 1106, or a specific video in the message video payload 1108).
Message story identifier 1118: identifier values identifying one or more content collections (e.g., “stories” identified in the collections table 618) with which a particular content item in the message image payload 1106 of the message 1100 is associated. For example, multiple images within the message image payload 1106 may each be associated with multiple content collections using identifier values.
Message tag 1120: each message 1100 may be tagged with multiple tags, each of which is indicative of the subject matter of content included in the message payload. For example, where a particular image included in the message image payload 1106 depicts an animal (e.g., a lion), a tag value may be included within the message tag 1120 that is indicative of the relevant animal. Tag values may be generated manually, based on user input, or may be automatically generated using, for example, image recognition.
Message sender identifier 1122: an identifier (e.g., a messaging system identifier, email address, or device identifier) indicative of a user of the user system 402 on which the message 1100 was generated and from which the message 1100 was sent.
Message receiver identifier 1124: an identifier (e.g., a messaging system identifier, email address, or device identifier) indicative of a user of the user system 402 to which the message 1100 is addressed.

The contents (e.g., values) of the various components of message 1100 may be pointers to locations in tables within which content data values are stored. For example, an image value in the message image payload 1106 may be a pointer to (or address of) a location within an image table 616. Similarly, values within the message video payload 1108 may point to data stored within an image or video table, values stored within the message augmentation data 1112 may point to data stored in an augmentation table 612, values stored within the message story identifier 1118 may point to data stored in a collections table 618, and values stored within the message sender identifier 1122 and the message receiver identifier 1124 may point to user records stored within an entity table 608.

System with Head-Wearable Apparatus

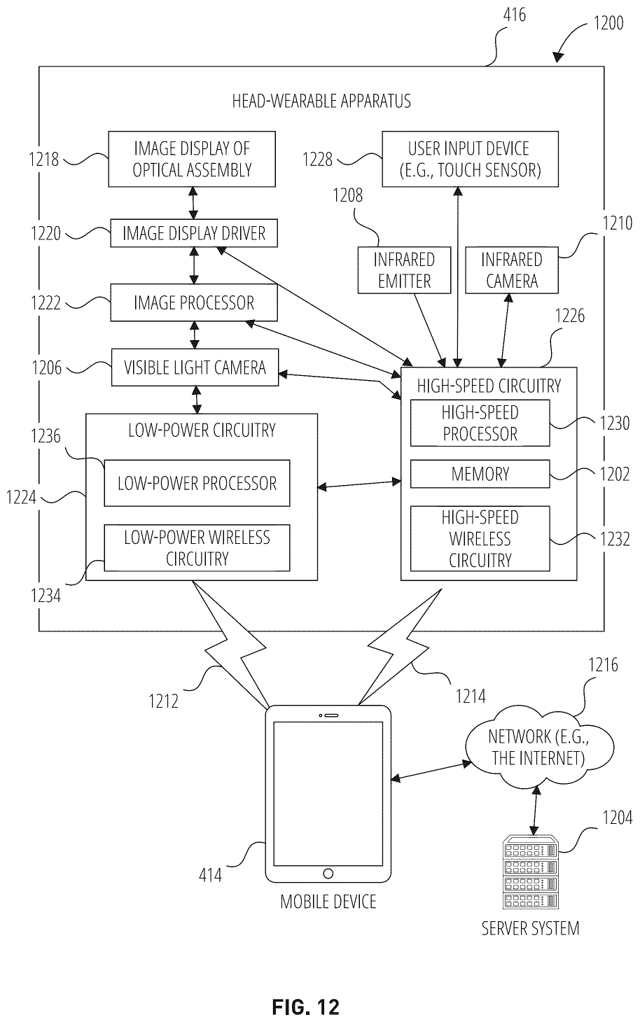

FIG. 12 illustrates a system 1200 including a head-wearable apparatus 416 with a selector input device, according to some examples. FIG. 12 is a high-level functional block diagram of an example head-wearable apparatus 416 communicatively coupled to a mobile device 414 and various server systems 1204 (e.g., the interaction server system 410) via various networks 408. The networks 408 may include any combination of wired and wireless connections.

The head-wearable apparatus 416 includes one or more cameras, each of which may be, for example, a visible light camera 1206, an infrared emitter 1208, and an infrared camera 1210.

An interaction client, such as a mobile device 414 connects with head-wearable apparatus 416 using both a low-power wireless connection 1212 and a high-speed wireless connection 1214. The mobile device 414 is also connected to the server system 1204 and the network 1216.

The head-wearable apparatus 416 further includes two image displays of the image display of optical assembly 1218. The two image displays of optical assembly 1218 include one associated with the left lateral side and one associated with the right lateral side of the head-wearable apparatus 416. The head-wearable apparatus 416 also includes an image display driver 1220, an image processor 1222, low-power circuitry 1224, and high-speed circuitry 1226. The image display of optical assembly 1218 is for presenting images and videos, including an image that can include a graphical user interface to a user of the head-wearable apparatus 416.

The image display driver 1220 commands and controls the image display of optical assembly 1218. The image display driver 1220 may deliver image data directly to the image display of optical assembly 1218 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 416 includes a frame and stems (or temples) extending from a lateral side of the frame. The head-wearable apparatus 416 further includes a user input device 1228 (e.g., touch sensor or push button), including an input surface on the head-wearable apparatus 416. The user input device 1228 (e.g., touch sensor or push button) is to receive from the user an input selection to manipulate the graphical user interface of the presented image.

The components shown in FIG. 12 for the head-wearable apparatus 416 are located on one or more circuit boards, for example a PCB or flexible PCB, in the rims or temples. Alternatively, or additionally, the depicted components can be located in the chunks, frames, hinges, or bridge of the head-wearable apparatus 416. Left and right visible light cameras 1206 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 416 includes a memory 1202, which stores instructions to perform a subset or all of the functions described herein. The memory 1202 can also include storage device.

As shown in FIG. 12, the high-speed circuitry 1226 includes a high-speed processor 1230, a memory 1202, and high-speed wireless circuitry 1232. In some examples, the image display driver 1220 is coupled to the high-speed circuitry 1226 and operated by the high-speed processor 1230 in order to drive the left and right image displays of the image display of optical assembly 1218. The high-speed processor 1230 may be any processor capable of managing high-speed communications and operation of any general computing system needed for the head-wearable apparatus 416. The high-speed processor 1230 includes processing resources needed for managing high-speed data transfers on a high-speed wireless connection 1214 to a wireless local area network (WLAN) using the high-speed wireless circuitry 1232. In certain examples, the high-speed processor 1230 executes an operating system such as a LINUX operating system or other such operating system of the head-wearable apparatus 416, and the operating system is stored in the memory 1202 for execution. In addition to any other responsibilities, the high-speed processor 1230 executing a software architecture for the head-wearable apparatus 416 is used to manage data transfers with high-speed wireless circuitry 1232. In certain examples, the high-speed wireless circuitry 1232 is configured to implement Institute of Electrical and Electronic Engineers (IEEE) 802.11 communication standards, also referred to herein as WI-FIR. In some examples, other high-speed communications standards may be implemented by the high-speed wireless circuitry 1232.

The low-power wireless circuitry 1234 and the high-speed wireless circuitry 1232 of the head-wearable apparatus 416 can include short-range transceivers (Bluetooth™) and wireless wide, local, or wide area network transceivers (e.g., cellular or WI-FI®). Mobile device 414, including the transceivers communicating via the low-power wireless connection 1212 and the high-speed wireless connection 1214, may be implemented using details of the architecture of the head-wearable apparatus 416, as can other elements of the network 1216.

The memory 1202 includes any storage device capable of storing various data and applications, including, among other things, camera data generated by the left and right visible light cameras 1206, the infrared camera 1210, and the image processor 1222, as well as images generated for display by the image display driver 1220 on the image displays of the image display of optical assembly 1218. While the memory 1202 is shown as integrated with high-speed circuitry 1226, in some examples, the memory 1202 may be an independent standalone element of the head-wearable apparatus 416. In certain such examples, electrical routing lines may provide a connection through a chip that includes the high-speed processor 1230 from the image processor 1222 or the low-power processor 1236 to the memory 1202. In some examples, the high-speed processor 1230 may manage addressing of the memory 1202 such that the low-power processor 1236 will boot the high-speed processor 1230 any time that a read or write operation involving memory 1202 is needed.

As shown in FIG. 12, the low-power processor 1236 or high-speed processor 1230 of the head-wearable apparatus 416 can be coupled to the camera (visible light camera 1206, infrared emitter 1208, or infrared camera 1210), the image display driver 1220, the user input device 1228 (e.g., touch sensor or push button), and the memory 1202.

The head-wearable apparatus 416 is connected to a host computer. For example, the head-wearable apparatus 416 is paired with the mobile device 414 via the high-speed wireless connection 1214 or connected to the server system 1204 via the network 1216. The server system 1204 may be one or more computing devices as part of a service or network computing system, for example, that includes a processor, a memory, and network communication interface to communicate over the network 1216 with the mobile device 414 and the head-wearable apparatus 416.

The mobile device 414 includes a processor and a network communication interface coupled to the processor. The network communication interface allows for communication over the network 1216, low-power wireless connection 1212, or high-speed wireless connection 1214. Mobile device 414 can further store at least portions of the instructions in the mobile device 114's memory to implement the functionality described herein.

Output components of the head-wearable apparatus 416 include visual components, such as a display such as a liquid crystal display (LCD), a plasma display panel (PDP), a light-emitting diode (LED) display, a projector, or a waveguide. The image displays of the optical assembly are driven by the image display driver 1220. The output components of the head-wearable apparatus 416 further include acoustic components (e.g., speakers), haptic components (e.g., a vibratory motor), other signal generators, and so forth. The input components of the head-wearable apparatus 416, the mobile device 414, and server system 1204, such as the user input device 1228, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 416 may also include additional peripheral device elements. Such peripheral device elements may include biometric sensors, additional sensors, or display elements integrated with the head-wearable apparatus 416. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1212 and high-speed wireless connection 1214 from the mobile device 414 via the low-power wireless circuitry 1234 or high-speed wireless circuitry 1232.

### Machine Architecture

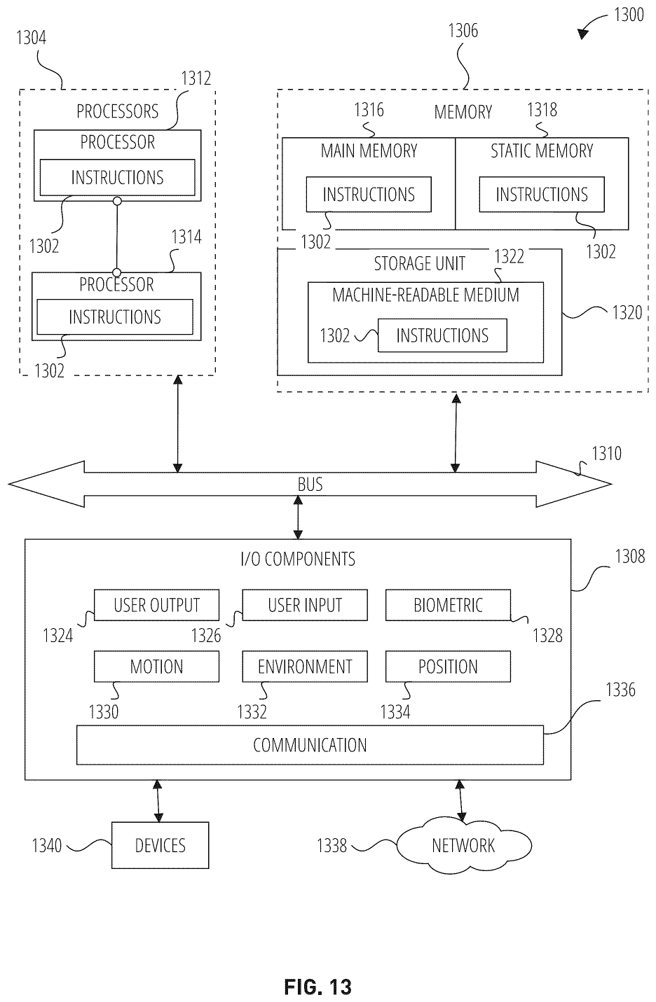

FIG. 13 is a diagrammatic representation of the machine 1300 within which instructions 1302 (e.g., software, a program, an application, an applet, an app, or other executable code) for causing the machine 1300 to perform any one or more of the methodologies discussed herein may be executed. For example, the instructions 1302 may cause the machine 1300 to execute any one or more of the methods described herein. The instructions 1302 transform the general, non-programmed machine 1300 into a particular machine 1300 programmed to carry out the described and illustrated functions in the manner described. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1302, sequentially or otherwise, that specify actions to be taken by the machine 1300. Further, while a single machine 1300 is illustrated, the term “machine” shall also be taken to include a collection of machines that individually or jointly execute the instructions 1302 to perform any one or more of the methodologies discussed herein. The machine 1300, for example, may comprise the user system 402 or any one of multiple server devices forming part of the interaction server system 410. In some examples, the machine 1300 may also comprise both client and server systems, with certain operations of a particular method or algorithm being performed on the server-side and with certain operations of the particular method or algorithm being performed on the client-side.

The machine 1300 may include processors 1304, memory 1306, and input/output I/O components 1308, which may be configured to communicate with each other via a bus 1310. In an example, the processors 1304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1312 and a processor 1314 that execute the instructions 1302. The term “processor” is intended to include multi-core processors that may comprise two or more independent processors (sometimes referred to as “cores”) that may execute instructions contemporaneously. Although FIG. 13 shows multiple processors 1304, the machine 1300 may include a single processor with a single-core, a single processor with multiple cores (e.g., a multi-core processor), multiple processors with a single core, multiple processors with multiples cores, or any combination thereof.

The memory 1306 includes a main memory 1316, a static memory 1318, and a storage unit 1320, both accessible to the processors 1304 via the bus 1310. The main memory 1306, the static memory 1318, and storage unit 1320 store the instructions 1302 embodying any one or more of the methodologies or functions described herein. The instructions 1302 may also reside, completely or partially, within the main memory 1316, within the static memory 1318, within machine-readable medium 1322 within the storage unit 1320, within at least one of the processors 1304 (e.g., within the processor's cache memory), or any suitable combination thereof, during execution thereof by the machine 1300.

The I/O components 1308 may include a wide variety of components to receive input, provide output, produce output, transmit information, exchange information, capture measurements, and so on. The specific I/O components 1308 that are included in a particular machine will depend on the type of machine. For example, portable machines such as mobile phones may include a touch input device or other such input mechanisms, while a headless server machine will likely not include such a touch input device. It will be appreciated that the I/O components 1308 may include many other components that are not shown in FIG. 13. In various examples, the I/O components 1308 may include user output components 1324 and user input components 1326. The user output components 1324 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1326 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1308 may include biometric components 1328, motion components 1330, environmental components 1332, or position components 1334, among a wide array of other components. For example, the biometric components 1328 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1330 include acceleration sensor components (e.g., accelerometer), gravitation sensor components, rotation sensor components (e.g., gyroscope).

The environmental components 1332 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 402 may have a camera system comprising, for example, front cameras on a front surface of the user system 402 and rear cameras on a rear surface of the user system 402. The front cameras may, for example, be used to capture still images and video of a user of the user system 402 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 402 may also include a 360° camera for capturing 360° photographs and videos.

Further, the camera system of the user system 402 may include dual rear cameras (e.g., a primary camera as well as a depth-sensing camera), or even triple, quad or penta rear camera configurations on the front and rear sides of the user system 402. These multiple cameras systems may include a wide camera, an ultra-wide camera, a telephoto camera, a macro camera, and a depth sensor, for example.

The position components 1334 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1308 further include communication components 1336 operable to couple the machine 1300 to a network 1338 or devices 1340 via respective coupling or connections. For example, the communication components 1336 may include a network interface component or another suitable device to interface with the network 1338. In further examples, the communication components 1336 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1340 may be another machine or any of a wide variety of peripheral devices (e.g., a peripheral device coupled via a USB).

Moreover, the communication components 1336 may detect identifiers or include components operable to detect identifiers. For example, the communication components 1336 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1336, such as location via Internet Protocol (IP) geolocation, location via Wi-Fi® signal triangulation, location via detecting an NFC beacon signal that may indicate a particular location, and so forth.

The various memories (e.g., main memory 1316, static memory 1318, and memory of the processors 1304) and storage unit 1320 may store one or more sets of instructions and data structures (e.g., software) embodying or used by any one or more of the methodologies or functions described herein. These instructions (e.g., the instructions 1302), when executed by processors 1304, cause various operations to implement the disclosed examples.

The instructions 1302 may be transmitted or received over the network 1338, using a transmission medium, via a network interface device (e.g., a network interface component included in the communication components 1336) and using any one of several well-known transfer protocols (e.g., hypertext transfer protocol (HTTP)). Similarly, the instructions 1302 may be transmitted or received using a transmission medium via a coupling (e.g., a peer-to-peer coupling) to the devices 1340.

### Software Architecture

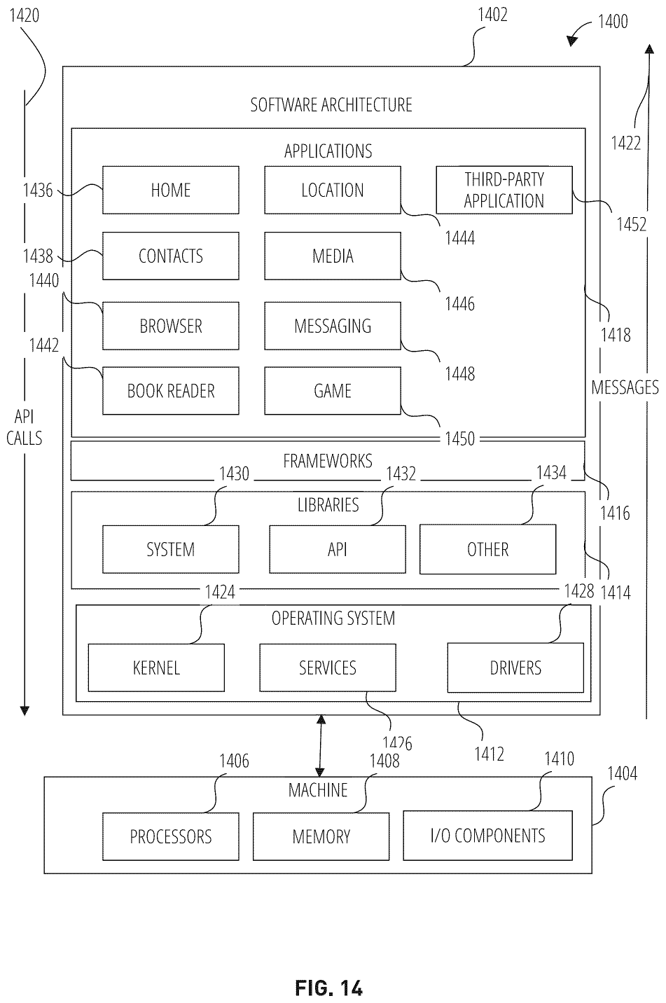

FIG. 14 is a block diagram 1400 illustrating a software architecture 1402, which can be installed on any one or more of the devices described herein. The software architecture 1402 is supported by hardware such as a machine 1404 that includes processors 1406, memory 1408, and I/O components 1410. In this example, the software architecture 1402 can be conceptualized as a stack of layers, where each layer provides a particular functionality. The software architecture 1402 includes layers such as an operating system 1412, libraries 1414, frameworks 1416, and applications 1418. Operationally, the applications 1418 invoke API calls 1420 through the software stack and receive messages 1422 in response to the API calls 1420.

The operating system 1412 manages hardware resources and provides common services. The operating system 1412 includes, for example, a kernel 1424, services 1426, and drivers 1428. The kernel 1424 acts as an abstraction layer between the hardware and the other software layers. For example, the kernel 1424 provides memory management, processor management (e.g., scheduling), component management, networking, and security settings, among other functionalities. The services 1426 can provide other common services for the other software layers. The drivers 1428 are responsible for controlling or interfacing with the underlying hardware. For instance, the drivers 1428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1414 provide a common low-level infrastructure used by the applications 1418. The libraries 1414 can include system libraries 1430 (e.g., C standard library) that provide functions such as memory allocation functions, string manipulation functions, mathematic functions, and the like. In addition, the libraries 1414 can include API libraries 1432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1414 can also include a wide variety of other libraries 1434 to provide many other APIs to the applications 1418.

The frameworks 1416 provide a common high-level infrastructure that is used by the applications 1418. For example, the frameworks 1416 provide various graphical user interface (GUI) functions, high-level resource management, and high-level location services. The frameworks 1416 can provide a broad spectrum of other APIs that can be used by the applications 1418, some of which may be specific to a particular operating system or platform.

In an example, the applications 1418 may include a home application 1436, a contacts application 1438, a browser application 1440, a book reader application 1442, a location application 1444, a media application 1446, a messaging application 1448, a game application 1450, and a broad assortment of other applications such as a third-party application 1452. The applications 1418 are programs that execute functions defined in the programs. Various programming languages can be employed to create one or more of the applications 1418, structured in a variety of manners, such as object-oriented programming languages (e.g., Objective-C, Java, or C++) or procedural programming languages (e.g., C or assembly language). In a specific example, the third-party application 1452 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1452 can invoke the API calls 1420 provided by the operating system 1412 to facilitate functionalities described herein.

### Machine-Learning Pipeline

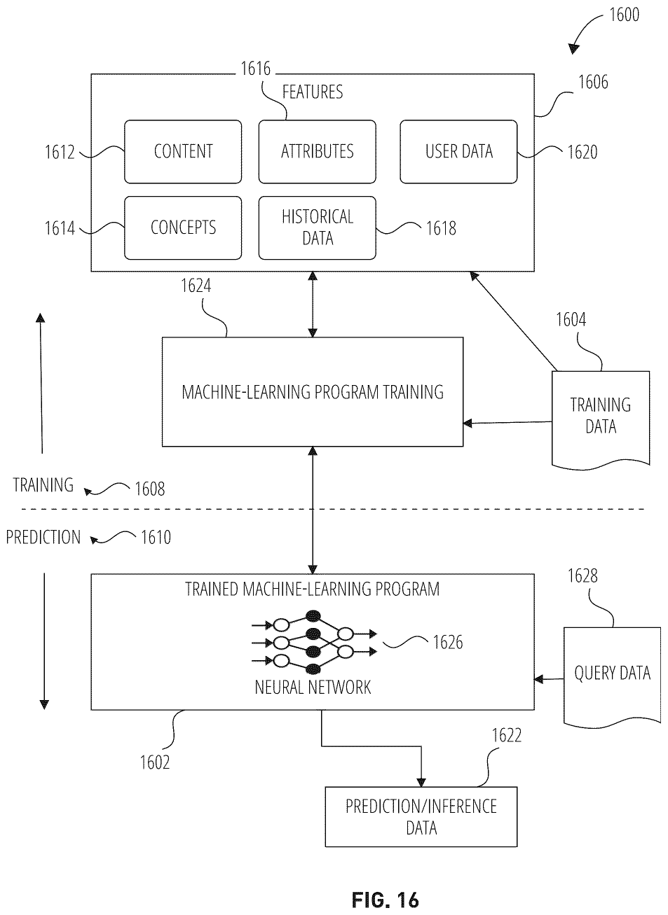

FIG. 16 is a flowchart depicting a machine-learning pipeline 1600, according to some examples. The machine-learning pipelines 1600 may be used to generate a trained model, for example the trained machine-learning program 1602 of FIG. 16, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

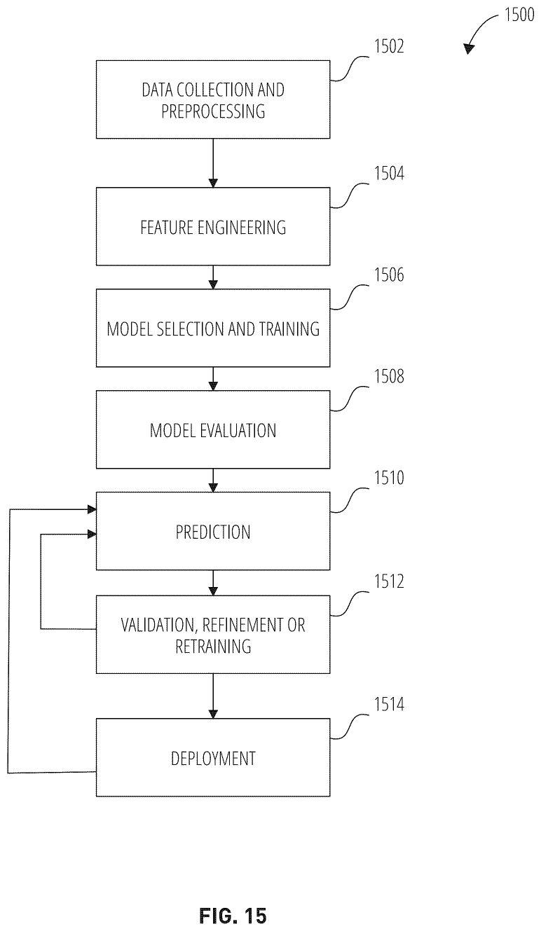

Generating a trained machine-learning program 1602 may include multiple types of phases that form part of the machine-learning pipeline 1600, including for example the following phases 1500 illustrated in FIG. 15:
Data collection and preprocessing 1502: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1504: This may include selecting and transforming the training data 1604 to create features that are useful for predicting the target variable. Feature engineering may include (1) receiving features 1606 (e.g., as structured or labeled data in supervised learning) and/or (2) identifying features 1606 (e.g., unstructured or unlabeled data for unsupervised learning) in training data 1604.
Model selection and training 1506: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1508: This may include evaluating the performance of a trained model (e.g., the trained machine-learning program 1602) on a separate testing dataset. This can help determine if the model is overfitting or underfitting and if it is suitable for deployment.
Prediction 1510: This involves using a trained model (e.g., trained machine-learning program 1602) to generate predictions on new, unseen data.
Validation, refinement or retraining 1512: This may include updating a model based on feedback generated from the prediction phase, such as new data or user feedback.
Deployment 1514: This may include integrating the trained model (e.g., the trained machine-learning program 1602) into a larger system or application, such as a web service, mobile app, or IoT device. This can involve setting up APIs, building a user interface, and ensuring that the model is scalable and can handle large volumes of data.

FIG. 16 illustrates two example phases, namely a training phase 1608 (part of the model selection and trainings 1506) and a prediction phase 1610 (part of prediction 1510). Prior to the training phase 1608, feature engineering 1504 is used to identify features 1606. This may include identifying informative, discriminating, and independent features for the effective operation of the trained machine-learning program 1602 in pattern recognition, classification, and regression. In some examples, the training data 1604 includes labeled data, which is known data for pre-identified features 1606 and one or more outcomes.

Each of the features 1606 may be a variable or attribute, such as individual measurable property of a process, article, system, or phenomenon represented by a data set (e.g., the training data 1604). Features 1606 may also be of different types, such as numeric features, strings, vectors, matrices, encodings, and graphs, and may include one or more of content 1612, concepts 1614, attributes 1616, historical data 1618 and/or user data 1620, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1608, the machine-learning pipeline 1600 uses the training data 1604 to find correlations among the features 1606 that affect a predicted outcome or prediction/inference data 1622.

With the training data 1604 and the identified features 1606, the trained machine-learning program 1602 is trained during the training phase 1608 during machine-learning program training 1624. The machine-learning program training 1624 appraises values of the features 1606 as they correlate to the training data 1604. The result of the training is the trained machine-learning program 1602 (e.g., a trained or learned model).

Further, the training phase 1608 may involve machine learning, in which the training data 1604 is structured (e.g., labeled during preprocessing operations), and the trained machine-learning program 1602 implements a relatively simple neural network 1626 capable of performing, for example, classification and clustering operations. In other examples, the training phase 1608 may involve deep learning, in which the training data 1604 is unstructured, and the trained machine-learning program 1602 implements a deep neural network 1626 that is able to perform both feature extraction and classification/clustering operations.

A neural network 1626 may, in some examples, be generated during the training phase 1608, and implemented within the trained machine-learning program 1602. The neural network 1626 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1626 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1626 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1608, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1626 is iteratively trained by adjusting model parameters to minimize a specific loss function or maximize a certain objective. The system can continue to train the neural network 1626 by adjusting parameters based on the output of the validation, refinement, or retraining block 1512, and rerun the prediction 1510 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1626 even after deployment 1514 of the neural network 1626. The neural network 1626 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1610, the trained machine-learning program 1602 uses the features 1606 for analyzing query data 1628 to generate inferences, outcomes, or predictions, as examples of a prediction/inference data 1622. For example, during prediction phase 1610, the trained machine-learning program 1602 is used to generate an output. Query data 1628 is provided as an input to the trained machine-learning program 1602, and the trained machine-learning program 1602 generates the prediction/inference data 1622 as output, responsive to receipt of the query data 1628. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1602 may be a generative AI model. Generative AI is a term that may refer to any type of artificial intelligence that can create new content from training data 1604. For example, generative AI can produce text, images, video, audio, code or synthetic data that are similar to the original data but not identical.

Some of the Techniques that May be Used in Generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1622 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: accessing a two-dimensional (2D) camera image captured by a camera on an augmented reality (AR) head-mounted device; generating a first set of tracked three-dimensional (3D) points using an odometry system on the AR head-mounted device on the 2D camera image; generating a second set of tracked 3D points by inputting one or more images captured by the camera into a first machine learning model; creating a relative depth image by projecting the first and second set of tracked 3D points onto the 2D camera image; and generating a metric depth estimation by inputting the 2D camera image and the depth image into a second machine learning model.

In Example 2, the subject matter of Example 1 includes, D camera image includes intensity information.

In Example 3, the subject matter of Examples 1-2 includes, D camera image includes a color image of a current view of a user of the AR head-mounted device.

In Example 4, the subject matter of Examples 1-3 includes, D coordinates as a user of the AR head-mounted device moves.

In Example 5, the subject matter of Examples 1-4 includes, D points using the odometry system includes applying one or more computer vision algorithms to estimate the AR head-mounted device's motion and applying an inertial measurement unit that includes one or more accelerometers or gyroscopes that measure acceleration and rotation respectively to determine changes in position of the AR head-mounted device.

In Example 6, the subject matter of Examples 1-5 includes, D camera image.

In Example 7, the subject matter of Examples 1-6 includes, D camera image.

In Example 8, the subject matter of Examples 1-7 includes, D point detection.

In Example 9, the subject matter of Examples 1-8 includes, D points for objects in motion, wherein the odometry system is trained for static objects.

In Example 10, the subject matter of Examples 1-9 includes, wherein the first machine learning model is trained to detect one or more hands of a user of the AR head-mounted device.

In Example 11, the subject matter of Example 10 includes, D points that include at least joint positions of a detected hand of the user.

In Example 12, the subject matter of Examples 1-11 includes, D camera image.

In Example 13, the subject matter of Examples 1-12 includes, D camera image.

In Example 14, the subject matter of Examples 1-13 includes, D camera image.

In Example 15, the subject matter of Examples 1-14 includes, wherein the operations further comprise: identifying a boundary based on the second set of tracked 3D points; and removing tracked 3D points within the boundary in the first set of tracked 3D points to generate a modified first set of tracked 3D points, wherein creating the relative depth image by projecting the first and second set of tracked 3D points onto the 2D camera image includes projecting the modified first set of tracked 3D points onto the 2D camera image.

In Example 16, the subject matter of Examples 1-15 includes, wherein the operations further comprise: identifying a boundary based on the second set of tracked 3D points; removing tracked 3D points within the boundary in the first set of tracked 3D points to generate a modified first set of tracked 3D points; and adding the second set of tracked 3D points to the modified first set of tracked 3D points to generate a third set of tracked 3D points, wherein creating the relative depth image by projecting the first and second set of tracked 3D points onto the 2D camera image includes projecting the third set of tracked 3D points onto the 2D camera image.

In Example 17, the subject matter of Examples 1-16 includes, wherein the operations further comprise: removing depth data from the metric depth estimation that corresponds to the boundary to generate an updated metric depth estimation; and generating a 3D virtual representation of the scene shown in the 2D camera image by applying the updated metric depth estimation.

In Example 18, the subject matter of Examples 1-17 includes, wherein the operations further comprise applying a global correction factor to the metric depth estimation by determining a difference between points on the relative depth image and the metric depth estimation.

Example 19 is a method comprising: accessing a two-dimensional (2D) camera image captured by a camera on an augmented reality (AR) head-mounted device; generating a first set of tracked three-dimensional (3D) points using an odometry system on the AR head-mounted device on the 2D camera image; generating a second set of tracked 3D points by inputting one or more images captured by the camera into a first machine learning model; creating a relative depth image by projecting the first and second set of tracked 3D points onto the 2D camera image; and generating a metric depth estimation by inputting the 2D camera image and the depth image into a second machine learning model.

Example 20 is a non-transitory computer-readable storage medium storing instructions that, when executed by at least one processor, cause the at least one processor to perform operations comprising: accessing a two-dimensional (2D) camera image captured by a camera on an augmented reality (AR) head-mounted device; generating a first set of tracked three-dimensional (3D) points using an odometry system on the AR head-mounted device on the 2D camera image; generating a second set of tracked 3D points by inputting one or more images captured by the camera into a first machine learning model; creating a relative depth image by projecting the first and second set of tracked 3D points onto the 2D camera image; and generating a metric depth estimation by inputting the 2D camera image and the depth image into a second machine learning model.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
accessing a two-dimensional (2D) camera image captured by a camera on an augmented reality (AR) head-mounted device;
generating a first set of tracked three-dimensional (3D) points using an odometry system on the AR head-mounted device on the 2D camera image;
generating a second set of tracked 3D points based on one or more images captured by the camera;
creating a sparse depth image by projecting the first and second set of tracked 3D points onto the 2D camera image; and
generating a metric depth estimation by inputting the 2D camera image and the sparse depth image into a first machine learning model.

2. The system of claim 1, wherein the camera includes a monocular camera, wherein the 2D camera image includes intensity information.

3. The system of claim 1, wherein the 2D camera image includes a color image of a current view of a user of the AR head-mounted device.

4. The system of claim 1, wherein generating the first set of tracked 3D points using the odometry system includes tracking spatial movement of the 3D coordinates as a user of the AR head-mounted device moves.

5. The system of claim 1, wherein generating the first set of tracked 3D points using the odometry system includes applying one or more computer vision algorithms to estimate the AR head-mounted device's motion and applying an inertial measurement unit that includes one or more accelerometers or gyroscopes that measure acceleration and rotation respectively to determine changes in position of the AR head-mounted device.

6. The system of claim 1, wherein generating the first set of tracked 3D points using the odometry system includes tracking corners of objects in view in the 2D camera image.

7. The system of claim 1, wherein generating the first set of tracked 3D points using the odometry system includes tracking edges of objects in view in the 2D camera image.

8. The system of claim 1, wherein generating the second set of tracked 3D points is by inputting the one or more images captured by the camera into a second machine learning model, the second machine learning model is trained for near field 3D point detection.

9. The system of claim 1, wherein generating the second set of tracked 3D points is by inputting the one or more images captured by the camera into a second machine learning model, the second machine learning model is trained for detecting 3D points for objects in motion, wherein the odometry system is optimized for static objects.

10. The system of claim 1, wherein generating the second set of tracked 3D points is by inputting the one or more images captured by the camera into a second machine learning model, the second machine learning model is trained to detect one or more hands of a user of the AR head-mounted device.

11. The system of claim 10, wherein generating the second set of tracked 3D points is by inputting the one or more images captured by the camera into a second machine learning model, the second machine learning model outputs the second set of tracked 3D points that include at least joint positions of a detected hand of the user.

12. The system of claim 1, wherein the one or more images includes the 2D camera image.

13. The system of claim 1, wherein the one or more images are of a different resolution than the 2D camera image.

14. The system of claim 1, wherein the one or more images are of a different field of view than the 2D camera image.

15. The system of claim 1, wherein the operations further comprise:
identifying a boundary based on the second set of tracked 3D points; and
removing tracked 3D points within the boundary in the first set of tracked 3D points to generate a modified first set of tracked 3D points,
wherein creating the sparse depth image by projecting the first and second set of tracked 3D points onto the 2D camera image includes projecting the modified first set of tracked 3D points onto the 2D camera image.

16. The system of claim 1, wherein the operations further comprise:
identifying a boundary based on the second set of tracked 3D points;
removing tracked 3D points within the boundary in the first set of tracked 3D points to generate a modified first set of tracked 3D points; and
adding the second set of tracked 3D points to the modified first set of tracked 3D points to generate a third set of tracked 3D points,
wherein creating the sparse depth image by projecting the first and second set of tracked 3D points onto the 2D camera image includes projecting the third set of tracked 3D points onto the 2D camera image.

17. The system of claim 16, wherein the operations further comprise:
removing depth data from the metric depth estimation that corresponds to the boundary to generate an updated metric depth estimation; and
generating a 3D virtual representation of the scene shown in the 2D camera image by applying the updated metric depth estimation.

18. The system of claim 1, wherein the operations further comprise applying a global correction factor to the metric depth estimation by determining a difference between points on the sparse depth image and the metric depth estimation.

19. A method comprising:
accessing a two-dimensional (2D) camera image captured by a camera on an augmented reality (AR) head-mounted device;
generating a first set of tracked three-dimensional (3D) points using an odometry system on the AR head-mounted device on the 2D camera image;
generating a second set of tracked 3D points based on one or more images captured by the camera;
creating a sparse depth image by projecting the first and second set of tracked 3D points onto the 2D camera image; and
generating a metric depth estimation by inputting the 2D camera image and the sparse depth image into a first machine learning model.

20. A non-transitory computer-readable storage medium storing instructions that, when executed by at least one processor, cause the at least one processor to perform operations comprising:
accessing a two-dimensional (2D) camera image captured by a camera on an augmented reality (AR) head-mounted device;
generating a first set of tracked three-dimensional (3D) points using an odometry system on the AR head-mounted device on the 2D camera image;
generating a second set of tracked 3D points based on one or more images captured by the camera;
creating a sparse depth image by projecting the first and second set of tracked 3D points onto the 2D camera image; and
generating a metric depth estimation by inputting the 2D camera image and the sparse depth image into a first machine learning model.
